(19) United States
(12) Patent Application Publication
(10) Pub. No.: US 2013/0110291 A1
(43) Pub. Date: May 2, 2013

(54) NOVEL SYSTEMS AND METHODS FOR PRODUCING BIOFUEL FROM ONE OR MORE VALUES OF PROCESS PARAMETERS

(71) Applicants: Nicholas CARLIN, Bay Point, CA (US); John J. McNamara, El Sobrante, CA (US); Pauravi SHAH, San Francisco, CA (US); Sumer JOHAL, Walnut Creek, CA (US)

(72) Inventors: Nicholas CARLIN, Bay Point, CA (US); John J. McNamara, El Sobrante, CA (US); Pauravi SHAH, San Francisco, CA (US); Sumer JOHAL, Walnut Creek, CA (US)

(73) Assignee: AGNI CORPORATION (CAYMAN ISLANDS)

(21) Appl. No.: 13/284,867

(22) Filed: Oct. 28, 2011

(51) Int. Cl. G05B 19/02

(52) U.S. Cl. 700/272

(57) ABSTRACT

Inventive systems and methods for satisfying demands of fuel having desired properties (e.g., a desired value of higher heating value on a dry basis) are described. The systems and methods of the present invention ensure production of fuel having desired properties by correlating fuel properties with certain process parameters. These parameters are relevant to the process of producing fuel from biomass. Processing regimes for certain values of parameters that provide increased throughput of fuel production are identified.

### FIELD OF THE INVENTION

The present invention relates to novel systems and methods for producing fuel from biomass. More particularly, the present invention relates to novel systems and methods for producing fuel having desired predetermined properties from diverse biomass.

### BACKGROUND OF THE INVENTION

High demand for fuel and energy, and a decrease in conventional energy supplies, such as oil and natural gas, are driving exploration of renewable energy sources such as biofuels. Renewable energy sources are desirable because they are available long after conventional energy supplies have been depleted. Specifically, biomass, a resource abundantly and renewably present in nature, is the source for production of biofuels.

Biomass can be of many different types. One example of biomass is agricultural waste, often referred to as agro-waste. Agro-waste, in turn, can be of many different types. Examples of agro-waste include rice straw, sugarcane leaves and corn stover. As would be expected, certain types of agro-waste are more commonly available over other types in a geographic region, depending typically on the types of crops favored in that region. Consequently, abundance of different types of agro-waste varies from region to region.

Different types of agro-waste have different chemical constituents or different physical properties. As a result, fuel produced from one type of agro-waste has different fuel properties compared to fuel produced from another type of agro-waste. Moreover, fuel produced from one type of agro-waste commonly found in one region has different fuel properties compared to the fuel produced from the same type or another type of agro-waste commonly found in another region.

Unfortunately, current systems and processes for producing fuel from biomass suffer from drawbacks. By way of example, it is very difficult to produce fuel having specific, desirable fuel properties from diverse biomass in a commercially viable manner. Although biomass diversity spans across different regions, it is necessary to produce fuel having specific properties across those regions. For various energy-driven applications across different regions, where the need for an energy source having specific fuel properties is a must, producing fuel from diverse types of biomass does not present a commercially viable solution.

Current systems and processes, which attempt to produce fuel from biomass, do so by developing a unique system design and a unique fuel production process for a particular type of biomass. Expending such efforts in the hopes of producing fuel with specific, desirable properties is time consuming, and represents an expensive and arduous task.

What is therefore needed are novel systems and methods that harness energy from diverse types of biomass without suffering from the drawbacks encountered by the conventional systems and processes of biomass treatment.

### SUMMARY OF THE INVENTION

In view of the foregoing, in one aspect, the present invention provides novel systems and methods for producing biofuel from one or more values of process parameters.

In one aspect, the present invention discloses a method of producing a fuel from biomass. The method includes: (1) obtaining an information and one process parameter for a type of biomass, the information defining a relationship among time of processing the biomass, temperature of the biomass during processing and a property of the fuel, preferably mass yield, and values of the time of processing the biomass and values of the temperature of the biomass during processing correlate according to a value of temperature ramp rate of the biomass during processing, and the process parameter includes at least one member selected from a group consisting of the time of processing of the biomass, the temperature of the biomass during processing, and the temperature ramp rate of the biomass during processing; (2) accessing a value for the property of the fuel on a dry, ash-free basis, wherein the property of the fuel includes one member selected from a group consisting of higher heating value, mass yield, volatile matter, fixed carbon, amount of carbon, amount of oxygen and amount of hydrogen; (3) determining a value of another process parameter for the biomass type using the property of the fuel on a dry, ash-free basis and the one process parameter; and (4) processing, using the value of another process parameter for the type of biomass, of the biomass to produce the fuel.

In another aspect, the present invention provides another method of producing a fuel from biomass. The method includes: (1) obtaining values of a temperature ramp rate of the biomass during processing and values of one process parameter selected from a group consisting of a time of processing of the biomass and a temperature of the biomass during processing; (2) obtaining an information for a type of the biomass, the information defining a relationship among the time of processing the biomass, the temperature of the biomass during processing and a property of the fuel, and the values of the time of processing the biomass and the values of the temperature of the biomass during processing correlate according to the value of temperature ramp rate of the biomass during processing; (3) determining a value of the property of the fuel on a dry, ash-free basis, for the biomass type using the values of the temperature ramp rate of the biomass during processing and the value of the one process parameter, and wherein the property of the fuel includes one member selected from a group consisting of higher heating value, mass yield, volatile matter, fixed carbon, amount of carbon, amount of oxygen and amount of hydrogen; and (4) processing the biomass using the value of the property of the fuel on a dry, ash-free basis, to produce the fuel.

In yet another aspect, the present invention discloses yet another method of producing a fuel from biomass. The method includes: (1) obtaining information and two process parameters for a type of biomass, the information defining a relationship between a property of the fuel on a dry, ash-free basis, and time of processing of the biomass, when the biomass is held at a constant temperature after being heated to the constant temperature based on a value of a temperature ramp rate, and a correlation between the property of the fuel and the time of processing of the biomass at the constant temperature of the biomass depends upon a value of the constant temperature and a temperature ramp rate of the biomass, and the process parameter includes the time of processing of the biomass, the constant temperature, and the temperature ramp rate of the biomass; (2) accessing a value for a property of the fuel on a dry, ash-free basis, wherein the property of the fuel includes one member selected from a group consisting of higher heating value, mass yield, volatile matter, fixed carbon, amount of carbon, amount of oxygen and amount of hydrogen; (3) determining another process parameter using the property of the fuel on a dry, ash-free basis and the process parameter; and (4) facilitating combustion of fuel or processing of biomass using the another process parameter.

In yet another aspect, the present invention discloses yet another method of producing a fuel from biomass. The method includes: (1) obtaining values of a temperature ramp rate of the biomass during processing, a time of processing of the biomass and a constant temperature of the biomass during processing; (2) obtaining an information for a type of the biomass, the information defining a relationship between the property of the fuel on a dry, ash-free basis, and time of processing of the biomass, when the biomass is held at the constant temperature after being heated to the constant temperature based on a value of a temperature ramp rate, and a correlation between the property of the fuel and the time of processing of the biomass at the constant temperature of the biomass depends upon the value of the constant temperature and the value of the temperature ramp rate of the biomass; (3) determining a value of the property of the fuel on a dry, ash-free basis, for the biomass type using the values of the temperature ramp rate of the biomass during processing and the value of the one process parameter, and wherein the property of the fuel includes one member selected from a group consisting of higher heating value, mass yield, volatile matter, fixed carbon, amount of carbon, amount of oxygen and amount of hydrogen; and (4) processing the biomass using the value of the property of the fuel on a dry, ash-free basis, to produce the fuel.

In yet another aspect, the present invention discloses a system for producing a fuel from biomass. The system includes: (1) a means for obtaining an information and one process parameter for a type of biomass, the information defining a relationship among time of processing the biomass, temperature of the biomass during processing and a property of the fuel, and values of the time of processing the biomass and values of the temperature of the biomass during processing correlate according to a value of temperature ramp rate of the biomass during processing, and the process parameter includes at least one member selected from a group consisting of the time of processing of the biomass, the temperature of the biomass during processing, and the temperature ramp rate of the biomass during processing; (2) a means for accessing a value for the property of the fuel on a dry, ash-free basis, wherein the property of the fuel includes one member selected from a group consisting of higher heating value, mass yield, volatile matter, fixed carbon, amount of carbon, amount of oxygen and amount of hydrogen; (3) a means for determining a value of another process parameter for the biomass type using the property of the fuel on a dry, ash-free basis and the one process parameter; and (4) a means for processing, using the value of another process parameter for the biomass type, of the biomass to produce the fuel.

In yet another aspect, the present invention discloses another system for producing a fuel from biomass. The system includes: (1) a means for obtaining values of a temperature ramp rate of the biomass during processing and values of one process parameter selected from a group consisting of a time of processing of the biomass and a temperature of the biomass during processing; (2) a means for obtaining an information for a type of the biomass, the information defining a relationship among the time of processing the biomass, the temperature of the biomass during processing and a property of the fuel, and the values of the time of processing the biomass and the values of the temperature of the biomass during processing correlate according to the value of temperature ramp rate of the biomass during processing; (3) a means for determining a value of the property of the fuel on a dry, ash-free basis, for the biomass type using the values of the temperature ramp rate of the biomass during processing and the value of the one process parameter, and wherein the property of the fuel includes one member selected from a group consisting of higher heating value, mass yield, volatile matter, fixed carbon, amount of carbon, amount of oxygen and amount of hydrogen; and (4) a means for processing the biomass using the value of the property of the fuel on a dry, ash-free basis, to produce the fuel.

In yet another aspect, the present invention discloses yet another system for producing a fuel from biomass. The system includes: (1) a means for obtaining information and two process parameters for a type of biomass, the information defining a relationship between a property of the fuel on a dry, ash-free basis, and time of processing of the biomass, when the biomass is held at a constant temperature after being heated to the constant temperature based on a value of a temperature ramp rate, and a correlation between the property of the fuel and the time of processing of the biomass at the constant temperature of the biomass depends upon a value of the constant temperature and a temperature ramp rate of the biomass, and the process parameter includes the time of processing of the biomass, the constant temperature and the temperature ramp rate of the biomass; (2) a means for accessing a value for a property of the fuel on a dry, ash-free basis, wherein the property of the fuel includes one member selected from a group consisting of higher heating value, mass yield, volatile matter, fixed carbon, amount of carbon, amount of oxygen and amount of hydrogen; (3) a means for determining another process parameter using the property of the fuel on a dry, ash-free basis and the process parameter; and (4) a means for facilitating combustion of fuel or processing of biomass using the another process parameter.

In yet another aspect, the present invention discloses yet another system for producing a fuel from biomass. The system includes: (1) a means for obtaining values of a temperature ramp rate of the biomass during processing, a time of processing of the biomass and a constant temperature of the biomass during processing; (2) a means for obtaining an information for a type of the biomass, the information defining a relationship between the property of the fuel on a dry, ash-free basis, and time of processing of the biomass, when the biomass is held at the constant temperature after being heated to the constant temperature based on a value of a temperature ramp rate, and a correlation between the property of the fuel and the time of processing of the biomass at the constant temperature of the biomass depends upon the value of the constant temperature and the value of the temperature ramp rate of the biomass; (3) a means for determining a value of the property of the fuel on a dry, ash-free basis, for the biomass type using the values of the temperature ramp rate of the biomass during processing and the value of the one process parameter, and wherein the property of the fuel includes one member selected from a group consisting of higher heating value, mass yield, volatile matter, fixed carbon, amount of carbon, amount of oxygen and amount of hydrogen; and (4) a means for processing the biomass using the value of the property of the fuel on a dry, ash-free basis, to produce the fuel.

### BRIEF DESCRIPTION OF THE DRAWINGS

FIG. 1 is a block diagram of an interactive environment, according to one embodiment of the present invention, showing different systems involved in production and sale of biomass-based fuel.

FIG. 2 is an exemplar embodiment of a Customized Fuel Analysis Server System used for implementing various aspects/features of a Fuel Production Management Facility.

FIG. 3 is a functional block diagram of a Customized Fuel Analysis Server System, in accordance with one embodiment of the present invention.

FIG. 4A is a graph of elemental content of biomass on a dry, ash-free basis, plotted against mass yield of fuel on a dry, ash-free basis, in accordance with a preferred embodiment of the present invention.

FIG. 4B is graph of elemental mass percentage of biomass on a dry, ash-free basis, plotted against mass yield of fuel on dry, ash-free basis, in accordance with a preferred embodiment of the present invention.

FIG. 5 is a graph of higher heating value for particular types of biomass or fuel plotted against carbon/oxygen ratio, in accordance with a preferred embodiment of the present invention, for particular types of biomass or fuel.

FIG. 6 is a graph of carbon/oxygen ratio for biomass or fuel plotted against volatile matter of biomass or fuel expressed as a percentage of weight on a dry, ash-free basis, in accordance with a preferred embodiment of the present invention.

FIG. 7 is a graph of volatile matter of biomass or fuel expressed as kg/100 kg of initial biomass on a dry, ash-free basis, plotted against mass yield of biomass or fuel on a dry, ash-free basis, in accordance with a preferred embodiment of the present invention.

FIG. 8 is a graph of volatile matter of biomass or fuel expressed as a percent, by weight, on a dry, ash-tree basis, plotted against mass yield of biomass or fuel on a dry, ash-free basis, in accordance with a preferred embodiment of the present invention.

FIG. 9 is a graph of ash content of biomass or fuel, expressed as a percent, by weight, on a dry basis, plotted against mass yield of biomass or fuel on a dry, ash-free basis, in accordance with a preferred embodiment of the present invention.

FIG. 10 shows a flowchart of a series of steps used to determine ash content, expressed as a percent, by weight, on a dry basis, that corresponds to the value for biomass yield on a dry, ash-free basis, in accordance with a preferred embodiment of the present invention.

FIG. 11 is a graph showing a temperature profiles and plots of mass yield over a period of time, according to one embodiment of the present invention, developed during a process of fuel production from biomass that was conducted at a ramp rate of 15° C./minute.

FIG. 12 is a graph showing a temperature profiles and plots of mass yield over a period of time, according to another embodiment of the present invention, developed during a process of fuel production from biomass that was conducted at a ramp rate of 50° C./minute.

### DETAILED DESCRIPTION OF THE PREFERRED EMBODIMENTS

In the following description, numerous specific details are set forth in order to provide a thorough understanding of the present invention. It will be apparent, however, to one skilled in the art that the present invention is practiced without limitation to some or all of these specific details. In other instances, well-known process steps have not been described in detail in order to not unnecessarily obscure the invention.

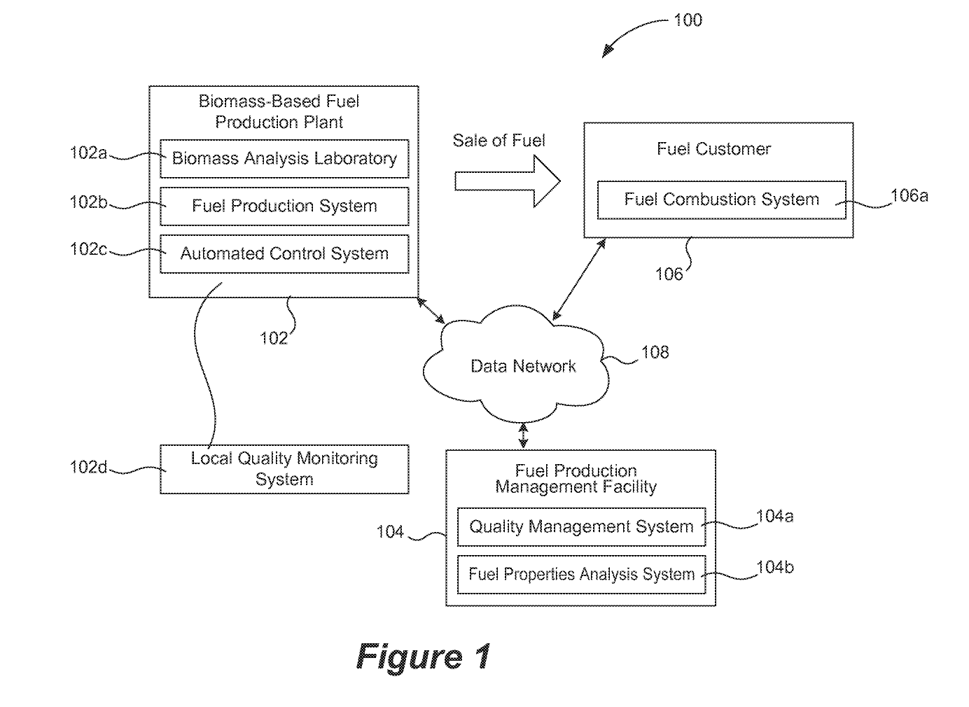

FIG. 1 is a block diagram of an interactive environment 100, according to one embodiment of the present invention, showing the different systems involved in production and sale of biomass-based fuel. In environment 100, a Biomass-Based Fuel Production Plant 102 and a Fuel Customer site 106 are communicatively coupled through a Data Network 108 to a Fuel Production Management Facility 104.

Biomass-Based Fuel Production Plant 102 produces fuel from biomass. The biomass is preferably agro-waste and more preferably, one or more different types of agro-waste. By way of example, the agro waste is at least one member selected from a group consisting of wood, guinea grass, rice straw, sugar cane leaves, cotton stalks, mustard stalks, pine needles, coffee husks, coconut husks, rice husks, mustard husks, weed straw, corn stover, sugar cane bagasse, millet stalks, pulses stalks, sweet sorghum stalks, nut shells, animal manure, guar husks, acacia totalis, julia flora, jatropha residue, wild grass, pigeon beans, pearl millet, barley, dry chili, gran jowar, linseed, maize/corn, lentil, mung bean, sunflower, till, oil seed stalks, pulses/millets, black gram, sawan, soybean stalks, cow gram, horse gram, finger millet, turmeric, castor seed, meshta, sannhamp, and hemp. Agro-waste need not be of different types for the biomass to be considered diverse. In fact, according to the present invention, two piles of biomass from the same type of agro-waste are diverse if they have different chemical or physical properties. By way of example, if one pile of corn stover has a different average particle size than another pile of corn stover, then according to the present invention, the two piles of corn stover are diverse.

Fuel Production Plant 102 includes a Biomass Analysis Laboratory 102a, Fuel Production System 102b, Automated Control System 102c. Biomass Analysis Laboratory 102a includes different components (e.g., a carbon-hydrogen-nitrogen-sulfur (“CHNS”) analyzer, a carbon-hydrogen-nitrogen-oxygen (“CHNO”) analyzer, a gaseous mass analyzer, a mass spectrometer, an infrared (“IR”) spectrometer, a thermal conductivity cell, a muffle furnace, an inert muffle furnace, a high-temperature oven, a solid fuel burner, a thermo-gravimetric analyzer, an IR spectrometer, a near infrared (“NIR”) spectrometer, an X-ray fluorescence spectrometer, a gamma ray absorber, a microwave absorber, a bomb calorimeter, a differential thermal analyzer, and a differential scanning calorimeter) to analyze various properties of biomass. A value for initial ash content is one property of the biomass that is frequently determined using an ash analysis system, such as a muffle furnace, an inert muffle furnace, a high-temperature oven, a solid fuel burner, a thermo-gravimetric analyzer, an IR spectrometer, a NIR spectrometer, an X-ray fluorescence spectrometer, a gamma ray absorber and a microwave absorber. Automated Control System 102c includes various process control equipment, which control the hardware components of a fuel production system 102b and that are involved in processing biomass into fuel. Fuel Production System 102b includes, among others, such equipment as a leaching chamber, a torrefaction chamber, a dewatering system and a drying system.

Fuel Production Management Facility 104 includes a Quality Monitoring System 104a and a fuel properties analysis system 104b. Quality Monitoring System 104a monitors one or more outputs from Fuel Production Plant 102, as a quality control measure, to ensure that biomass processing will produce fuel having requisite values for certain properties often dictated by Fuel Customer 106. Based on initial ash content of biomass provided by Biomass-Based Fuel Production Plant (preferably by Biomass Analysis Laboratory 102a) and a desired value for a particular fuel property obtained from Fuel Customer 106, Fuel Properties Analysis System 104b provides at least another fuel property to Biomass-Based Fuel Production Plant 102. Fuel Production Plant 102 uses that information to process biomass and produce a fuel having the desired properties. In preferred embodiments of the present invention, Fuel Production Management Facility 104 not only provides information regarding fuel properties to Fuel Production Plant 102, but also manages the production of fuel at that plant.

Fuel Customer 106 includes, among other things, a Fuel Combustion System 106a, which is used for burning the resulting fuel to produce energy for various applications. Depending on the application, Fuel Customer 106 specifies the desired value for a fuel property (e.g., typically higher heating value). To this end, Fuel Production Management Facility 104 manages the fuel production process carried out at a Fuel Production Plant 104 to produce the fuel having the specified properties by Fuel Customer 106.

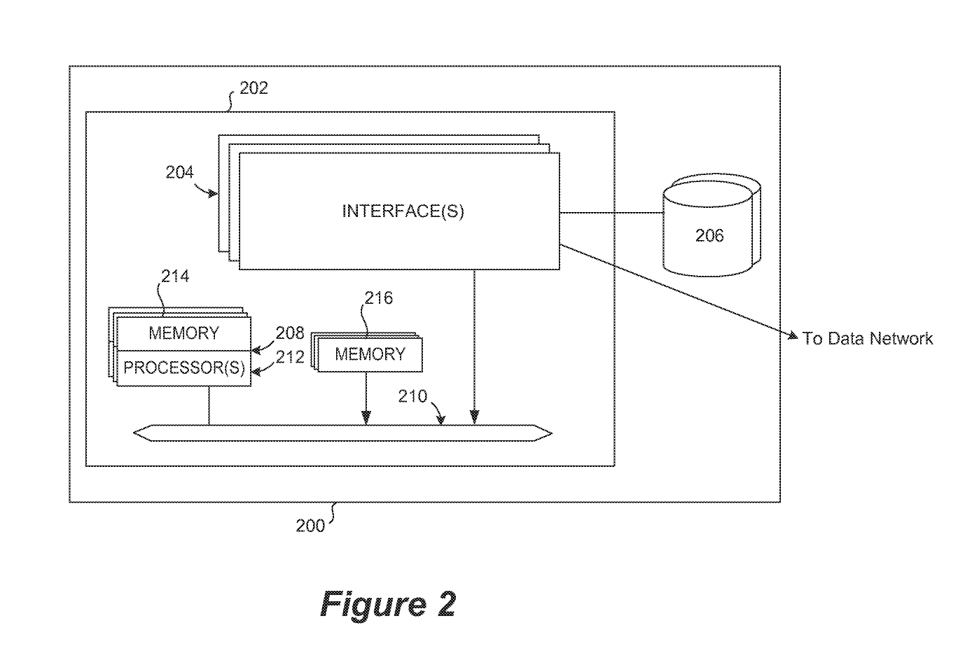

FIG. 2 illustrates an exemplar embodiment of a Customized Fuel Analysis Server System 200, which is used for implementing various aspects/features of Fuel Production Management Facility 104 described herein. In at least one embodiment, server system 200 of the present invention includes at least one network device 202, and at least one storage device 206 (such as, for example, a direct attached storage device).

According to one preferred embodiment of the present invention, network-device 202 may include a master central processing unit (CPU) 208, interfaces 204 and a bus 210 (e.g., a PCI bus). When acting under the control of appropriate software or firmware, CPU 208 is responsible for implementing specific functions associated with the functions of a desired network device. For example, when configured as a server, CPU 208 is responsible for analyzing packets, encapsulating packets, forwarding packets to appropriate network devices, instantiating various types of virtual machines, virtual interfaces, virtual storage volumes, and virtual appliances. CPU 208 preferably accomplishes at least a portion of these functions under the control of software including an operating system (e.g., Linux), and any-appropriate system software (such as, AppLogic™ software).

CPU 208 may include one or more processors 212, such as one or more processors from the AMD, Google (formerly Motorola), Intel and/or MIPS families of microprocessors. In an alternative embodiment, processor 212 of the present invention is specially designed hardware for controlling the operations of server system 200. In a specific embodiment, a memory 214 (such as non-volatile RAM and/or ROM) also forms part of CPU 208. However, there are many different ways in which memory could be coupled to the system. Memory block 214 is used for a variety of purposes such as, for example, caching and/or storing data, and programming instructions.

Interfaces 204 are typically provided as interface cards (sometimes referred to as “line cards”). Alternatively, one or more of interfaces 204 is provided as on-board interface controllers built into the system motherboard. Generally, they control the sending and receiving of data packets over the network and sometimes support other peripherals used with Customized Fuel Analysis Server System 200. Among the interfaces provided are FC interfaces, Ethernet interfaces, frame relay interfaces, cable interfaces, DSL interfaces, token ring interfaces, Infiniband interfaces and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, and DHEI interfaces. Other interfaces may include one or more wireless interfaces such as, for example, 802.11 (WiFi) interfaces, 802.15 interfaces (including Bluetooth™), 802.16 (WIMax) interfaces, 802.22 interfaces, Cellular standards such as CDMA interfaces, CDMA2000 interfaces, WCDMA interfaces, TDMA interfaces, and Cellular 3G interfaces.

Generally, one or more interfaces may include ports appropriate for communication with the appropriate media. In some cases, they may also include an independent processor, and in some instances, volatile RAM. The independent processors may control such communication-intensive tasks as packet switching, media control and management. By providing separate processors for the communications intensive tasks, these interfaces allow the master microprocessor 208 to efficiently perform routing computations, network diagnostics, security functions, etc.

In at least one embodiment, some interfaces are configured or designed to allow Customized Fuel Analysis Server System 200 to communicate with other network devices associated with various data networks including, but not limited to, local area network (LANs) and/or wide area networks (WANs). Other interfaces are configured or designed to allow network device 202 to communicate with one or more directly attached storage device(s) 206.

Although the system shown in FIG. 2 illustrates one specific network device described herein, it is by no means the only network device architecture on which one or more embodiments can be implemented. For example, an architecture having a single processor that handles communications as well as routing computations may be used. Further, other types of interfaces and media could also be used with the network device.

Regardless of network device's configuration, it may employ one or more memories or memory modules (such as, for example, memory block 216, which, for example, may include random access memory (RAM)) configured to store data, program instructions for the general-purpose network operations and/or other information relating to the functionality of the various fuel analysis techniques described herein. The program instructions may control the operation of an operating system and/or one or more applications, for example. The memory or memories may also be configured to store data structures, and/or other specific non-program information described herein.

Because such information and program instructions are employed to implement the systems/methods described herein, one or more embodiments relates to machine-readable media that include program instructions, state information, etc., for performing various operations described herein. Examples of machine-readable storage media include, but are not limited to, magnetic media such as hard disks, floppy disks, magnetic tape, optical media such as CD-ROM disks, magneto-optical media such as optical disks and hardware devices that are specially configured to store and perform program instructions, such as read-only memory (ROM) and random access memory (RAM) devices. Some embodiments may also be embodied in transmission media such as, for example, a earner wave travelling over an appropriate medium such as airwaves, optical lines and electric lines. Examples of program instructions include both machine code, such as that produced by a compiler, and files containing higher level code that is executed by the computer using an interpreter.

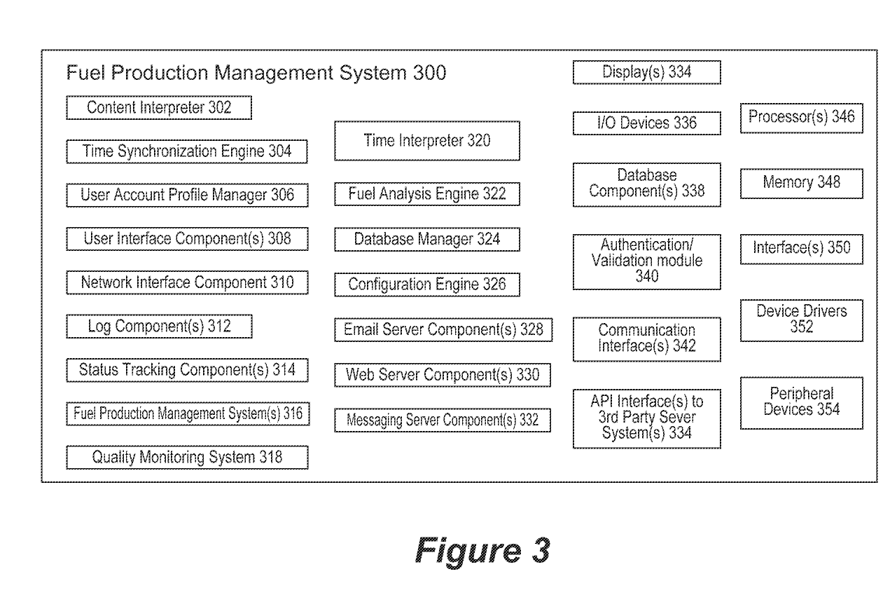

FIG. 3 illustrates an example of a functional block diagram of a Customized Fuel Analysis Server System 300, in accordance with a specific embodiment. Customized Fuel Analysis Server Systems 200 and 300 perform similar functions, but server system 300 of FIG. 3 shows major functional blocks that are present inside the server.

Customized Fuel Analysis Server System 300 includes context interpreter 302, time synchronization engine 304, user account profile manager 306, user interface component(s) 308, network interface component 310, log component(s) 312, status tracking component(s) 314, fuel production management system(s), quality monitoring system 318, time interpreter 320, payment processing engine 322, database manager 324, configuration engine 326, email server components) 328, web server components) 330, messaging server components) 332, display(s) 334, I/O devices 336, database components) 338, authentication validation module 340, communication interface(s) 342, API interface(s) to 3^{rd} party server system(s) 344, processor(s), memory 348, interface(s) 350, device drivers 352 and peripheral devices 354.

In at least one embodiment, the Customized Fuel Analysis Server System 300 is operable to perform and/or implement various types of functions, operations, actions, and/or other features such as, for example, one or more of the following (or combinations thereof):
calculate fuel properties on a dry, ash-free basis and on a dry basis; and
based on the calculated fuel properties, manage one or more fuel production plants.

Context Interpreter 302 is operable to automatically and/or dynamically analyze contextual criteria relating to a given request for analysis, and automatically determine or identify the type of fuel analysis to be performed. According to different embodiments, examples of contextual criteria that are analyzed may include, but are not limited to, one or more of the following (or combinations thereof):
location-based criteria—e.g., geoloeation of a biomass-based fuel production plant and of a fuel customer or fuel combustion site;
time-based criteria—e.g., time zone associated with the location of a biomass-based fuel production plant and of a fuel customer or fuel combustion site;
identity of a particular biomass-based fuel production plant where biomass has been or is going to be analyzed;
identify of a particular fuel customer or fuel combustion site that requires a fuel of a specified property;
profile information for both the biomass-based fuel production plant and fuel customer or fuel combustion site;
historical information for both the biomass-based fuel production plant and fuel customer or fuel combustion site (e.g., the type of biomass a particular fuel production plant available to it during a certain season of the year); and
recent production activities by a fuel production plant and recent purchase activities by a fuel customer.

For example, in at least one embodiment, the Customized Fuel Analysis Server System 300 of the present invention could collect trend data on purchasing behavior and project how much fuel a particular fuel customer would be purchasing during an upcoming season.

Time Synchronization Engine 304 is operable to manage universal time synchronization (e.g., via NTP and/or GPS). User Account Profile Manager 306 is operable to manage profiles information for both the biomass-based fuel production plant and fuel customer or fuel combustion site. User Interface Components) 308 is operable to manage interface component (e.g., interfaces 204 of FIG. 2). Network interface component 310 is operable to manage those interfaces 204 that interface with the network. Log Component(s) 312 is operable to generate and manage fuel analysis history logs, system errors, and connections from APIs. Status Tracking Component(s) 314 is operable to automatically and/or dynamically determine, assign, and/or report updated requests for fuel analysis, and provide status information based, for example, on the state of the request. In at least one embodiment of the present invention, the status of a given request is reported as one or more of the following (or combinations thereof): Completed, Incomplete, Pending, Invalid, Error, Declined, and Accepted. Fuel Production Management Systems 316 is operable to manage a fuel production plant (e.g. Fuel Production System 102b in a Fuel Production Plant 102 of FIG. 1). Quality Monitoring System 318 operates in a manner similar to Quality Monitoring System 104a of FIG. 1 described herein.

Time Interpreter 320 is operable to automatically and/or dynamically modify or change identifier activation and expiration time(s) based on various criteria such as, for example, time, location, or request status. Fuel Analysis Engine 322 is operable to handle various types of request processing tasks such as, for example, one or more of the following (or combinations thereof): identifying/determining request type and associating databases information to identifiers. Database Manager 324 is operable to handle various types of tasks relating to database updating, database management and database access. In at least one embodiment, the Database Manager is operable to manage TISS databases. Configuration Engine 326 is operable to determine and handle configuration of various customized configuration parameters for one or more devices, component(s), system(s), process(es), etc. Email server components) 328 is configured or designed to provide various functions and operations relating to email activities and communications. By way of example, with reference to FIG. 1, information about the biomass from Biomass-Based Fuel Production Plant 102 and/or information about fuel property from Fuel Customer 106 is provided to Fuel Production Management Facility 104 by email, Web server component(s) 330 is configured or designed to provide various functions and operations relating to web server activities and communications. Messaging server components) 332 is configured or designed to provide various functions and operations relating to text messaging and/or other social network messaging activities and/or communications. Social networking may be used in the context of present invention in many ways, e.g., tracking type and/or amount of biomass available from particular suppliers, establishing a bidding platform for purchase of biomass and/or fuel.

Display(s) 334 is operable to handle various tasks relating to displaying information on a computer screen, for example. I/O Device(s) 336 is operable to handle various tasks that require input and output devices, such as keyboards, mouse and computer display screens. Database Manager 338 is configured or designed to provide various functions and operating relating to management of a database. Authentication/Validation Component(s) 340 (password, software/hardware info, SSL certificates) which, for example, is operable to perform various types of authentication/validation tasks such as:
verifying/authenticating devices;
verifying passwords, passcodes, SSL certificates, biometric identification;
information, and/or other types of security-related information; and
verifying/validating activation and/or expiration times.

In one implementation, the Authentication/Validation Component(s) is adapted to determine and/or authenticate the identity of the current user or owner of the mobile client system. For example, in one embodiment of the present invention, the current user is required to perform a log-in process at the mobile client system in order to access one or more features. In some embodiments, the mobile client system may include biometric security components, which is operable to validate and/or authenticate the identity of a user by reading or scanning the user's biometric information (e.g., fingerprints, face, voice, and eye/iris). In at least one implementation, various security features is incorporated into the mobile client system to prevent unauthorized users from accessing confidential or sensitive information.

Communication Interface(s) 342 is operable to manage interface for communication applications, such as email and instant messaging. API Interface(s) to 3rd Party Server System(s) 344 is operable to facilitate and manage communications and transactions with API Interface(s) to 3rd Party Server System(s).

In at least one embodiment of the present invention, processor(s) 346 may include one or more commonly known CPUs that are deployed in many of today's consumer electronic devices, such as, for example, CPUs or processors from the Google (formerly Motorola) and/or the Intel family of microprocessors. In an alternative embodiment of the present invention, at least one processor is specially designed hardware for controlling the operations of the mobile client system. In a specific embodiment, a memory (such as non-volatile RAM and/or ROM) also forms part of CPU. When acting under the control of appropriate software or firmware, the CPU is responsible for implementing specific functions associated with the functions of a desired network device. The CPU preferably accomplishes all these functions under the control of software including an operating system, and any appropriate applications software.

Memory 348 may include volatile memory (e.g., RAM), non-volatile memory (e.g., disk memory, FLASH memory, and EPROMs), unalterable memory, and/or other types of memory. In at least one implementation of the present invention, memory 348 may include functionality similar to at least a portion of functionality implemented by one or more commonly known memory devices such as those described herein and/or generally known to one having ordinary skill in the art. According to different embodiments of the present invention, one or more memories or memory modules (e.g., memory blocks) are configured or designed to store data, program instructions for the functional operations of the mobile client system and/or other information relating to the functionality of the various fuel analysis techniques described herein. The program instructions may control the operation of an operating system and/or one or more applications, for example. The memory or memories may also be configured to store data structures, metadata, identifier information/images, and/or information/data relating to other features/functions described herein. Because such information and program instructions is employed to implement at least a portion of the systems located at Fuel Production Management Facility 104 described herein, various aspects described herein is implemented using machine-readable media that include program instructions, and state information.

Interface(s) 350 include wired interfaces and/or wireless interfaces. In at least one implementation of the present invention, interface(s) 350 include functionality similar to at least a portion of functionality implemented by one or more computer system interfaces such as those described herein (e.g., see Interfaces 204 of FIG. 2) and/or generally known to one having ordinary skill in the art. In at least one embodiment of the present invention, Device Driver(s) 352 include functionality similar to at least a portion of functionality implemented by one or more computer system driver devices such as those described herein and/or generally known to one having ordinary skill in the art. Peripheral Devices 354 include various peripheral devices, such as printers, image scanners, tape drives, microphones, loudspeakers, webcams, and digital cameras.

Systems and method of the present invention provide, among other things, certain empirical correlations that are independent of the type of biomass. These correlations, either used individually or collectively, provide one or more fuel properties preferably to a biomass-based fuel production plant.

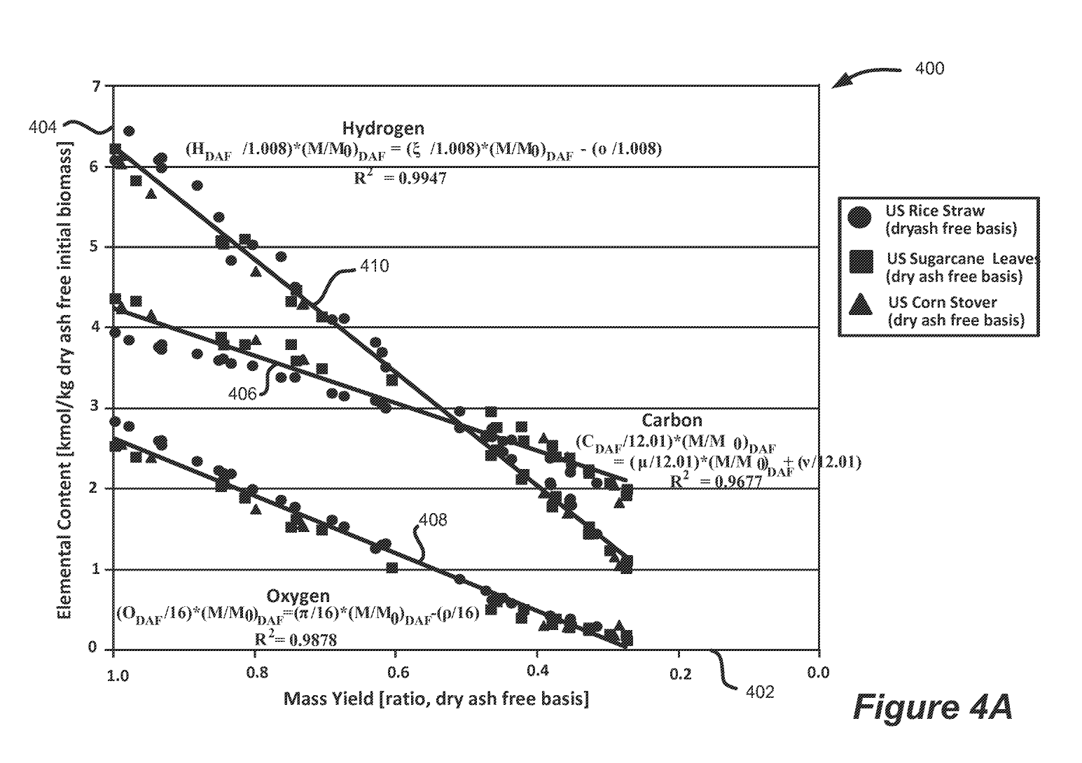

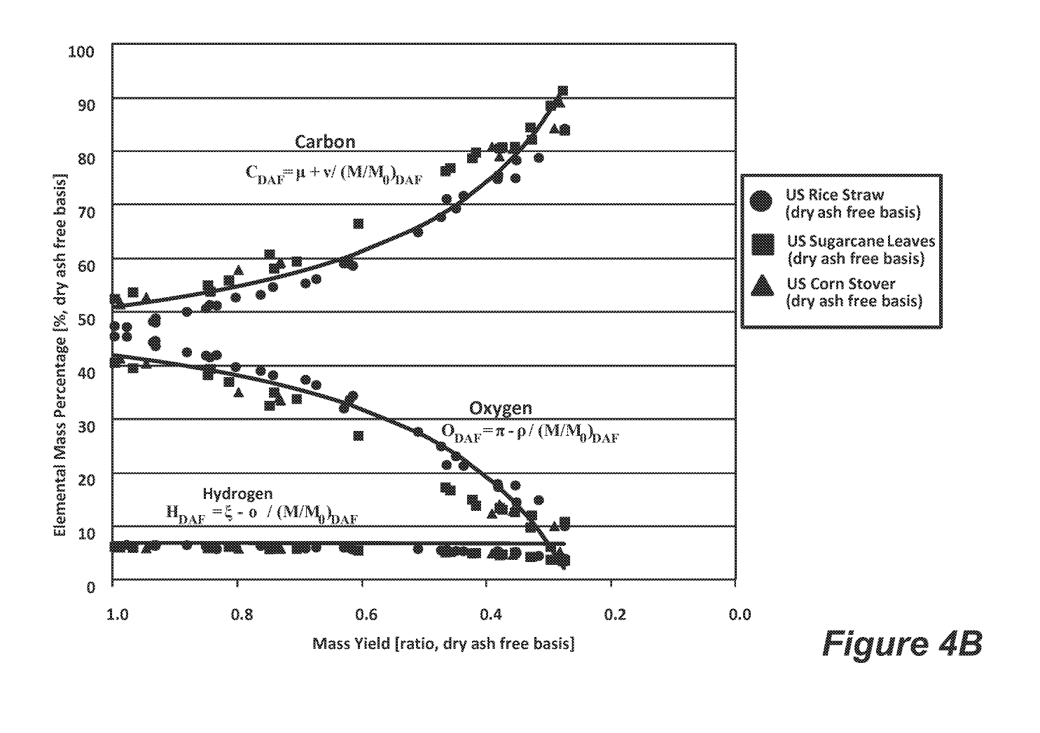

FIG. 4A shows a graph 400 where amounts of elemental content, such as carbon (C), hydrogen (H), and oxygen (O), found in biomass on a dry, ash-free (“DAF”) basis, are plotted on a Y-axis (denoted by reference numeral 404) and values of mass yield of fuel on a DAF basis are plotted on an X-axis (denoted by 402). The amount of elemental content is expressed in units of kmol/kg of DAF initial biomass. Mass yield, defined as a ratio of mass of fuel (M) to an initial mass of biomass (Mₒ), is a dimensionless quantity. Both M and Mₒ have units of mass.

In FIG. 4A, values for mass yield on a DAF basis are presented beginning with a value of 1.0 at the origin and then gradually decreasing to a value of 0.0 on the other end of X-axis. As biomass is processed to produce fuel, value of Mₒ decreases because the mass of fuel depletes over the processing time. Given that value of Mₒ is a constant, the yield is shown in FIG. 4A to decrease over a period of time. Those skilled in the art will appreciate that although the yield is shown to decrease, the energy density of the fuel increases over the processing time. In other words, although yield of fuel decreases over a period of time when biomass is subject to processing, there is an increase in yield of fuel having high energy density values over the same period of time. For sake of simplicity, values plotted on Y-axis 404 may be thought of as providing information on weight loss of biomass sample that is being converted to fuel.

FIG. 4A shows results for elemental content in diverse types of biomass, i.e., U.S. rice straw, U.S. sugarcane leaves, and U.S. corn stover. The amount of elemental content in the initial biomass may be measured using at least one member selected from a group consisting of a CHNS analyzer, a CHNO analyzer, a gaseous mass analyzer, a mass spectrometer, an IR spectrometer, and a thermal conductivity cell. By way of example, to arrive at the elemental contents shown in FIG. 4A, a Leco TruSpec Analyzer, commercially available from LECO Corporation, St. Joseph, Mich.

In FIG. 4A, yield, M/Mₒ was computed by measuring both M and Mₒ. By way of example, about 20 grams of each type of biomass was thermochemically treated at different times and temperatures in a GCF1300 Inert Gas Furnace, commercially available from Across International of Berkeley Heights, N.J. As a result, a value for Mₒ was ascertained before treating the different types of biomass. Mass yield was measured for each thermochemical experiment (i.e., each type of biomass was weighed before and after the thermochemical treatment). This direct measurement of M and Mₒ, however, provided values on an as-received basis (i.e., the values reflect the presence of ash and moisture). For the data plotted in FIG. 4A (as well as FIGS. 4B, 7, 8, 9, 11 and 12), which show values on a dry, ash-free basis, samples of the initial biomass and the resulting thermochemically treated samples were dried, ashed and weighed again after each drying and ashing step in a Leco TGA 701, which is commercially available from LECO Corporation of St. Joseph, Mich. Such steps were implemented to determine the amount of moisture and ash in both the biomass and the thermochemically treated samples. The measurements for both M and Mₒ were then corrected for moisture and ash to produce values on a dry, ash-free basis. Thus, the ratio of the corrected values of M and Mₒ is the mass yield on a dry, ash-free basis shown in FIGS. 4A, 4B, 7, 8, 9, 11 and 12, which are discussed in greater detail below. The above-described steps were not only carried out for all mass yield measurements described herein, but was also carried out for obtaining values of other fuel properties described here, i.e., higher heating value, volatile matter, carbon content, oxygen content and hydrogen content. Other equipment used to obtain values for such fuel properties is provided below in greater detail. It is noteworthy that measurement of other fuel properties, such as the measurement of mass yield, is provided on an as-received basis, which refers to dry basis. To provide corresponding values for these fuel properties on a dry, ash-free basis, ash and moisture content are measured and accounted for using the above-mention LECO TGA 701.

After the results obtained from measurements of elemental content and yield were plotted in FIG. 4A, linear regression analysis was conducted. A linear relationship for each of carbon 406, oxygen 408, and hydrogen 410 was obtained.

Linear relationship for carbon 406 is expressed by the following equation:

(C_{DAF}/32.01)*(M/M₀)_{DAF}=(μ/12.01)*(M/M₀)_{DAF}+(ν/12.01) (Equation 1)

In Equation 1, μ and ν are empirically derived constants. Furthermore, μ is a value that is between about 20 and 50, preferably between about 35 and about 36, and ν is a value that is between about 8 and about 25, preferably between about 15 and about 16. As explained above, C_{DAF} and (M/M₀)_{DAF} in Equation 1 refer to carbon and mass yield on a DAF basis, respectively.

Linear relationships for oxygen 408 and for hydrogen 410 were also similarly developed and are expressed in a similar manner below. Linear relationship for oxygen 408 is expressed by the following equation:

(O_{DAF}/16)*(M/M₀)_{DAF}=(π/16)*(M/M₀)_{DAF}−(ρ/16) (Equation 2)

In Equation 2, π is a value that is between about 30 and about 70, preferably between about 57 and about 58 and ρ is a value that is between about 8 and about 25, preferably between about 15 and about 16.

Linear relationship for hydrogen 410 is expressed as:

(H_{DAF}/1.008)*(M/M₀)_{DAF}=(ξ/1.0008)*(M/M₀)_{DAF}−(ο/1.0008) (Equation 3)

In Equation 3, ε is a value that is between about 2 and about 12, preferably between about 6 and about 8, and ο is a value that is between about 0.2 and about 1, preferably between about 0.7 and about 0.8.

For each linear relationships 406, 408 and 410 shown in FIG. 4A, a root mean square value, R² value, also known in the art as a “goodness of fit,” was computed to obtain insight into the strength of the correlation expressed in Equations 1, 2, and 3. For Equations 1-3, R² is about 0.97, 0.99 and 0.99, respectively. According to the present invention, regardless of the type of agro-waste or, in the alternative, type of biomass used to produce fuel, there is a strong correlation between the amount of each element (i.e., carbon, hydrogen and oxygen) and mass yield in the DAF regime. In other words, the present invention has established that in the DAF regime, the amount of elemental content and the mass yield enjoy a strong correlation independent of the type of underlying agro-waste or biomass used to produce fuel. This is particularly of interest because in the dry basis regime, in which most of the fuel specifications are provided and transactions for purchase of are carried out, such correlations between elemental content and mass yield simply do not exist.

FIG. 4B shows a graph similar to graph 400 of FIG. 4A where data points to arrive at the plots shown in FIG. 4B were obtained in a manner similar to those obtained to generate the plots shown in FIG. 4A, except the Y-axis in FIG. 4B shows values for elemental mass percentage having units of percent (%) on a DAF basis, instead of all linear relationships as shown in FIG. 4A, FIG. 4B shows certain non-linear relationships. From the plots for carbon, oxygen, and hydrogen shown in FIG. 4B, the following correlations are derived and correspond to Equations 1-3, respectively:

C_{DAF}=μ+ν/(M/M₀)_{DAF} (Equation 4)

H_{DAF}=ξ−ο/(M/M₀)_{DAF} (Equation 5)

O_{DAF}π−ρ/(M/M₀)_{DAF} (Equation 6)

In Equations 4, 5 and 6, the variables (I.e., C_{DAF}, H_{DAF}, O_{DAF} and M/M₀) are the same as those described in Equations 1-3. Similarly, constants, μ, ν, ξ, ο, π and ρ have the same values in Equations 4-6 as they do in Equations 1-3.

Equations 1-3, which are based on normalized values of elemental content (i.e., value of elemental content is multiplied by yield, M/M₀), represent a preferred embodiment of the present invention over Equations 4-6 because it is easier to fit a straight line to experimental data and achieve equations that show a strong correlation between the elemental content and mass yield in the DAF regime.

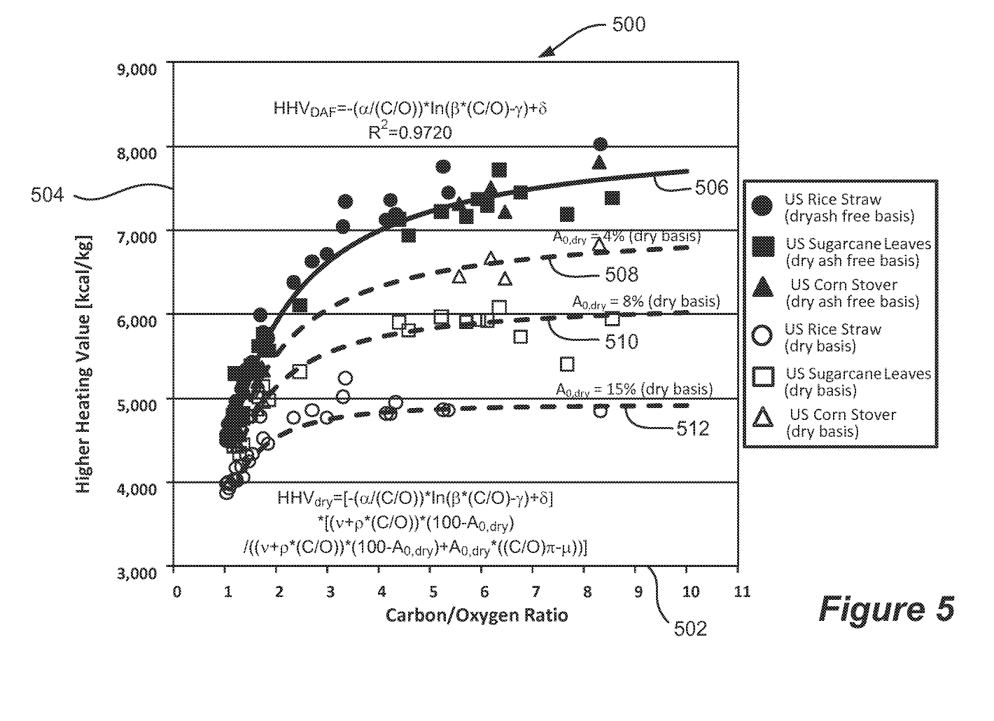

FIG. 5 shows a graph 500 where a higher heating value (HHV) for a particular biomass (i.e., U.S. rice straw, U.S. sugarcane leaves or U.S. corn stover) is plotted on a Y-axis (denoted by 504) and a ratio of amount of carbon to amount of oxygen (represented by “C/O”) present in biomass is plotted on an X-axis (denoted by 502), HHV is expressed in units of kcal/kg of fuel and represents the amount of heat produced by the complete combustion of a unit quantity of fuel. Although values of amount of carbon and of oxygen may have any suitable units that convey an amount of element contained in biomass, in preferred embodiments of the present invention, carbon and oxygen have units of percent (%), by weight.

In FIG. 5, HHV values are presented on a DAF basis in a plot 506, and presented on a dry basis in plots 508, 510 and 512. Those skilled in the art will recognize that C/O is a dimensionless quantity, and it does not matter whether the ratio is expressed on a DAF basis or on a dry basis, because in either basis the ratio would have the same value. C/O is obtained by computing the ratio of the amount of carbon to the amount of oxygen, where the amounts were determined using the techniques described in connection with FIG. 4A.

As explained below, values of HHV on a DAF basis were calculated from measured values of HHV on a dry basis. In one embodiment of the present invention, values of HHV on a dry basis are obtained measured using at least one member selected from a group consisting of a bomb calorimeter, a differential thermal analyzer (DTA), and a differential scanning calorimeter (DSC). To arrive at values of HHV on a dry basis for developing the correlations of the present invention, LECO AC600 Bomb Calorimeter, which is commercially available from LECO Corporation of St. Joseph, Mich., was used.

The present invention recognizes that to obtain values of HHV on a DAF basis from measured values of HHV on a dry basis, preferred embodiments of the present invention require knowledge of amounts of ash content on a dry basis (represented by “A_{dry}” in Equation 7 below) in the fuel, which is ultimately produced after processing of biomass. Knowledge of A_{dry}, in turn, preferably requires measuring the amounts of initial ash content present in the unprocessed biomass.

For each type of biomass, initial ash content (represented in Equations 7 and 9 as “A_{o,dry}”) may be measured using at feast one member selected from a group consisting of a muffle furnace, an inert muffle furnace, a high temperature oven, a solid fuel burner, a thermo-gravimetric analyzer, an infrared (“IR”) spectrometer, a near infrared (“NIR”) spectrometer, a gamma ray absorber, an X-ray fluorescence spectrometer and a microwave absorber.

To measure the amount of initial ash content of the biomass and arrive at the correlation presented in FIG. 5, the above-mentioned LECO TGA 701 analyzer was used.

From known amounts of initial ash content of biomass (i.e., A_{o,dry}) and known values of mass yield on a DAF basis (i.e., (M/M₀)_{DAF}), an amount of ash content on a dry basis (A_{dry}) in the fuel is calculated according to the following expression:

A_{dry}=100/(((M/M₀)_{DAF}*(100−A_{0,dry})/A_{0,dry})+1) (Equation 7)

Using A_{dry} and Equation 13, values of HHV on a dry basis are converted to values for that on a DAF basis. Plot 506 of FIG. 5 was developed using values of HHV on a DAF basis, and values of C/O. By performing a curve-fitting analysis on plot 506, the present invention provides the following correlation:

HHV_{DAF}=−(α/(C/O))*ln(β*(C/O)−γ)+δ (Equation 8)

In Equation 7, “HHV_{DAF}” represents HHV on a DAF basis, and α is a value that is between about 200 and about 300 and preferably between about 260 and 261, β is a value that is between about 1×10⁷ and about 1×10⁸ and preferably between about 5×10⁷ and about 6×10⁷, γ is a value that is between about 1×10⁷ and about 1×10⁸ and preferably between about 5×10⁷ and about 6×10⁷, and δ is a value that is between about 7000 and about 9000 and preferably between about 82.00 and 8300.

Similarly, using values of HHV on a dry basis (represented below as (“HHV)_{dry}”), each of plots 508, 510 and 512 are expressed as:

HHV_{dry}=[−(α/(C/O))*ln(β*(C/O)−γ)+δ]*[(ν+ρ*(C/O))*(100−A_{0,dry})/((ν+ρ*(C/O))*(100−A_{0,dry})+A_{0,dry}*((C/O)π−μ))] (Equation 9)

In Equation 9, α, β, γ and δ have the same values as shown above with respect to Equation 8. Furthermore, ν is a value that is between about 5 and 25 and preferably between about 15 and about 16, ρ is a value that is between about 8 and 25 and preferably between about 15 and about 16, π is a value that is between about 30 and about 70 and preferably between about 57 and about 58, and μ is a value that is between about 20 and about 50 and preferably between about 35 and about 36.

As shown by plots 508, 510 and 512 in FIG. 5, the correlation between HHV and C/O in the dry basis regime depends on the initial ash content of the biomass. For example, the particular batches of U.S. corn stover, U.S. sugarcane leaves, and U.S. rice straw that were tested each have an initial ash content of 4%, 8% and 15%, respectively. Thus, as the ash contents vary, so too does the correlation between (HHV)_{dry} and C/O. Moreover, as the amount of initial ash content in biomass increases, lower values of HHV are realized at different values of C/O.

In the DAF regime, the present invention has surprisingly and unexpectedly found this not to hold true. According to Equation 7 and plot 506 in FIG. 5, in the DAF regime, there exists a strong correlation (i.e., value of R² for plot 506 is about 0.97) between values of HHV and C/O that is independent of biomass type. Stated another way, the present invention establishes that, regardless of the type of biomass used for producing fuel, values of HHV and C/O enjoy a strong correlation in the DAF regime.

By way of example, if a Fuel Customer 106 of FIG. 1 specifies a desired value for (HHV)_{dry}, then according to the present invention using the inventive correlation presented in Equation 8 in conjunction with Equations 7 and 13, a corresponding value for C/O is obtained. Equation 8 is similarly used to obtain a value for HHV_{DAF} if a value for C/O is provided. If necessary, using equation 7, values for HHV_{DAF} are converted to HHV_{dry}.

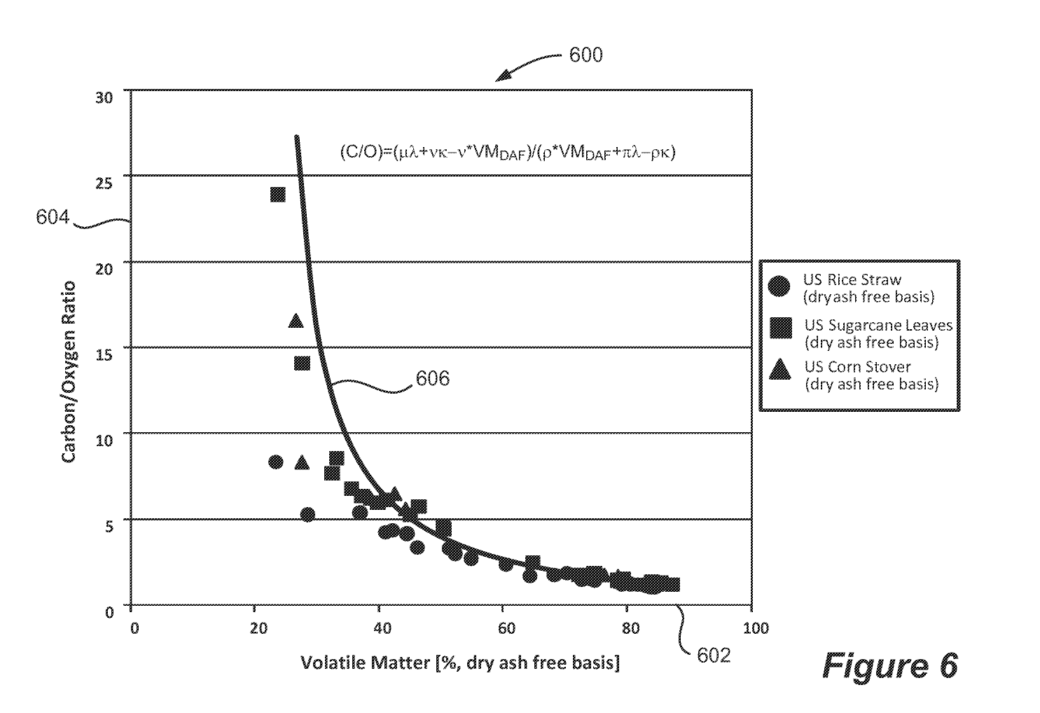

FIG. 6 shows a graph 600 where values for C/O are plotted on a Y-axis (denoted by 604), and amounts of volatile matter on a DAF basis are plotted on an X-axis (denoted by 602). Values for C/O shown in FIG. 6 are similar to the values presented for the ratio in FIG. 5, and are obtained in a manner similar to that described for the ratio in connection with FIG. 5.

Amount of volatile matter is expressed in units of percent (%), by weight. For each type of biomass, the amount of volatile matter on a DAF basis (represented in Equation 10 below as “VM_{DAF}”) may be determined using at least one member selected from a group consisting of a muffle furnace, an inert muffle furnace, a high temperature oven, a solid fuel burner, a thermo-gravimetric analyzer, an IR spectrometer, a NIR spectrometer, a gamma ray absorber and a microwave absorber. To arrive at the amount of volatile matter of the biomass presented in FIG. 6, the above-mentioned LECO TGA 701 analyzer was used.

A plot 606 was obtained using amounts of volatile matter on a DAF basis and corresponding values of C/O. As shown in FIG. 6, by performing a curve-fitting analysis on plot 606, the present invention provides the following correlation:

(C/O)=(μλ+νκ−ν*VM_{DAF})/(ρ*VM_{DAF}+πλ−ρκ) (Equation 10)

In Equation 10, ν, π, ρ and μ have the same values as in Equation 9. Furthermore, κ has a value that is between about 80 and about 120 and preferably between about 107 and about 108, and λ has a value that is between about 10 and about 35 and preferably between about 22 and about 23.

It is clear from FIG. 6 that regardless of the type of biomass used to produce fuel, the present invention provides a strong correlation between values of C/O and VM_{DAF}. Thus, for any type of biomass, if a value for C/O is known, a value for VM_{DAF} may be obtained using Equation 10. The converse is also true, i.e., for a known value of VM_{DAF} for any type of biomass, a value for C/O may be obtained using Equation 10.

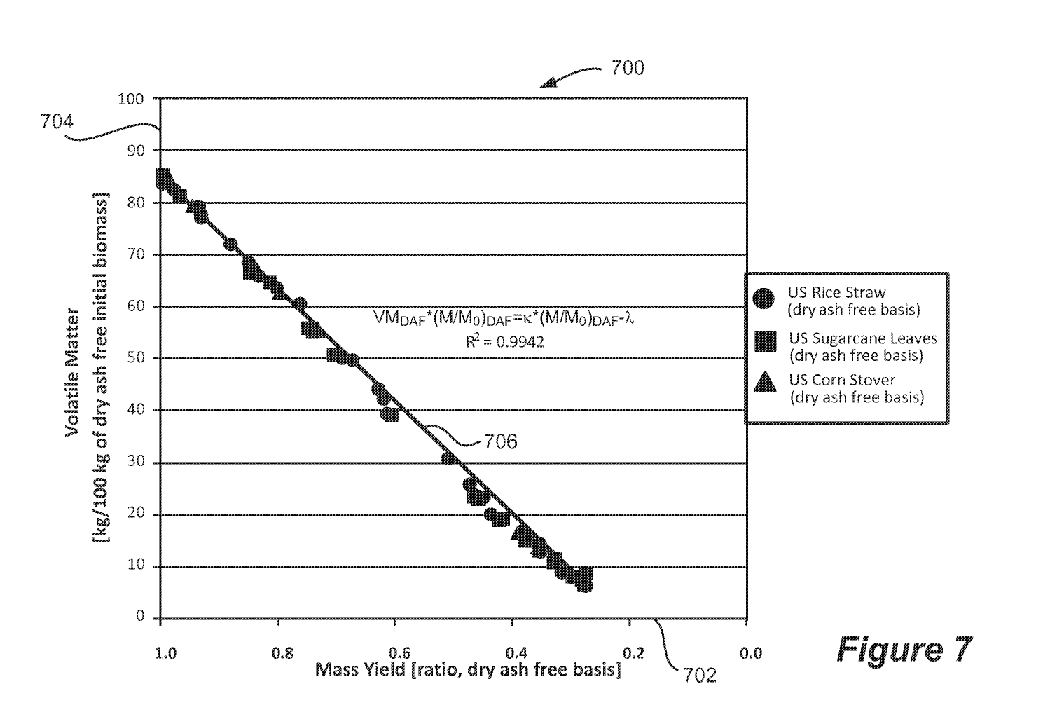

FIG. 7 shows a graph 700 in which amounts of VM_{DAF} are plotted on a Y-axis (denoted by 704) and values for mass yield on a DAF basis, i.e., (M/Mₒ)_{DAF}, are plotted on an X-axis (denoted by 702). Values for (M/Mₒ)_{DAF} shown in FIG. 7 are similar to the values presented for the ratio in FIG. 4A, and are obtained in a manner similar to that described for the ratio in connection with FIG. 4A and to develop Equations 1-6.

Amount of VM_{DAF} present in the biomass is expressed in units of kg of volatile matter/100 kg of dry, ash free unprocessed biomass. For each type of biomass, amount of volatile matter shown in FIG. 7 is obtained in a manner similar to that described for Equation 10, except the values along the Y-axis were normalized by multiplying the obtained volatile matter values with values for mass yield, M/Mₒ.

As shown in FIG. 7, a plot 706 was developed using amounts of volatile matter as discussed above and corresponding values of mass yield on a DAF basis (represented as “(M/Mₒ)DAF”). By performing a curve-fitting analysis on plot 706, the present invention provides the following correlation:

VM_{DAF}*(M/M₀)_{DAF}=κ*(M/M₀)_{DAF}−λ (Equation 11)

In Equation 11, constants κ and λ have the same values and preferred values as described in connection with Equation 10.

As with other correlations provided by the present invention, it is clear from FIG. 7 that regardless of the type of biomass used to produce fuel, the present invention provides a strong correlation between values of VM_{DAF}. Thus, for any type of biomass, if a value for VM_{DAF} is known, a value for (M/M₀)_{DAF} may be obtained using Equation 11. The converse is also true, i.e., for a known value of (M/Mₒ)_{DAF} for any type of biomass, a value for VM_{DAF} may be obtained using Equation 11.

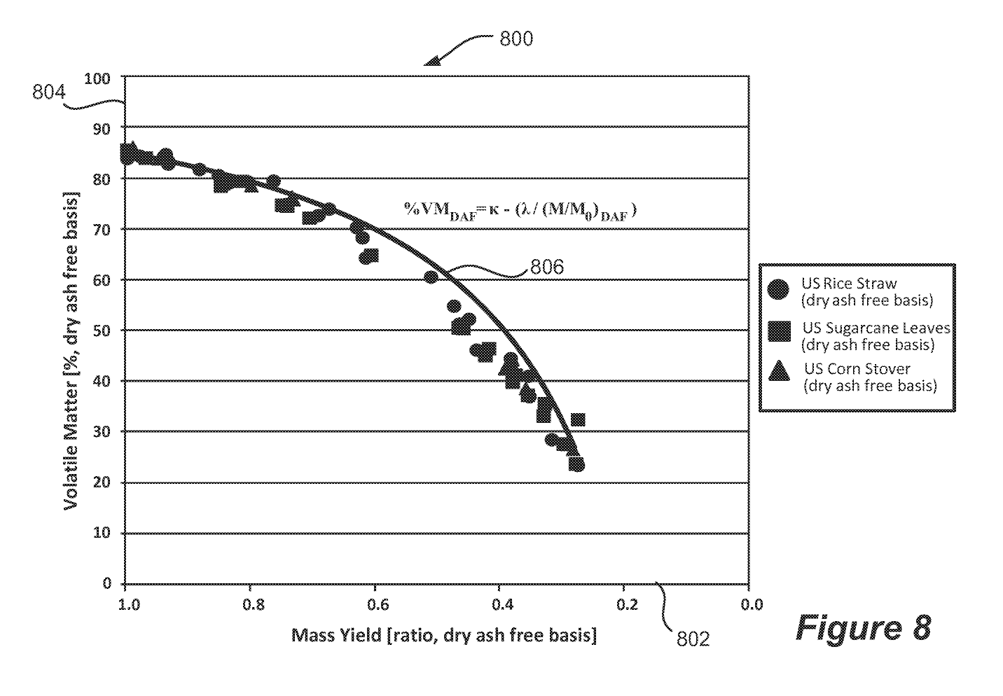

FIG. 8 shows a graph 800 similar to graph 700 of FIG. 7, where data points to arrive at the plots shown in FIG. 8 were obtained in a manner similar to those obtained to generate the plots shown in FIG. 7, except the Y-axis in FIG. 8 shows values for volatile matter having units of percent (%) on a DAF basis. Values of volatile matter in FIG. 8 were not normalized as they are in FIG. 7. A plot 806 was developed using values of VM_{DAF} and (M/Mₒ)_{DAF}. A curve fitting-analysis was performed on plot 806. Accordingly, the present invention provides the following correlation for VM_{DAF} and (M/Mₒ)_{DAF}:

Blade 106 is composed of any material that is rigid enough to handle the energy impinging upon it. Preferably, blade 106 is made from aluminum. In accordance with one embodiment of the present invention, blade 106 has a helical shape having a radius of curvature that is between about 1.0 m and about 3.0 m. A length of blade 106 is preferably between about 3.0 m and about 6.0 m and a thickness of blade 106 is preferably between about 1.0 inch and about 3.0 inches.

VM_{DAF}=κ−(λ/(M/M₀)_{DAF}) (Equation 12)

In Equations 12, constants κ and λ have the same values and preferred values, as described for Equations 10 and 11. Equation 11, which is based on normalized values of volatile matter on a DAF basis, represents a preferred embodiment of the present invention over Equation 12 because it is easier to fit a straight line to experimental data and achieve an equation that shows a strong correlation (according to FIG. 7, R² is about 0.99 for Equation 11) between values for volatile matter and mass yield in the DAF regime.

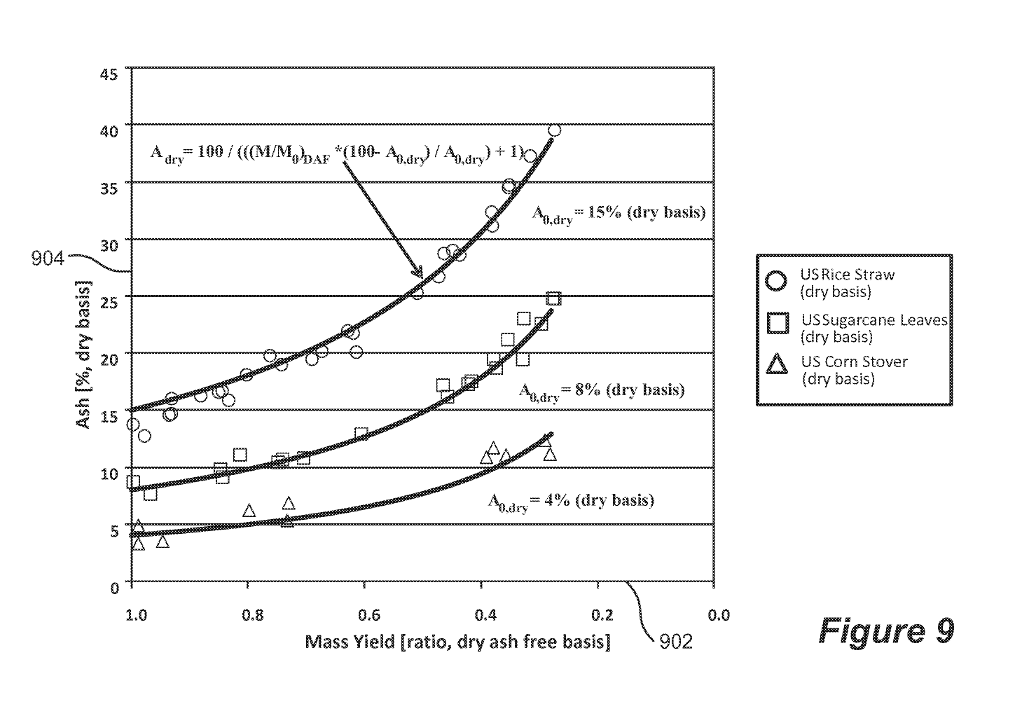

FIG. 9 shows values of ash content as a percent (%), by weight, on a dry-basis, plotted on a Y-axis (denoted by 904), and values of (M/M₀)_{DAF} are plotted on an X-axis (denoted by 902). Values for ash content and mass yield were obtained using techniques described above, and plots 906, 908 and 910 were developed as shown in FIG. 9, Each of plots 906, 908 and 910 are associated with a particular type of biomass. Following a curve-fitting analysis on plots 906, 908 and 910, the present invention recognizes that the correlation presented in Equation 7 is satisfied.

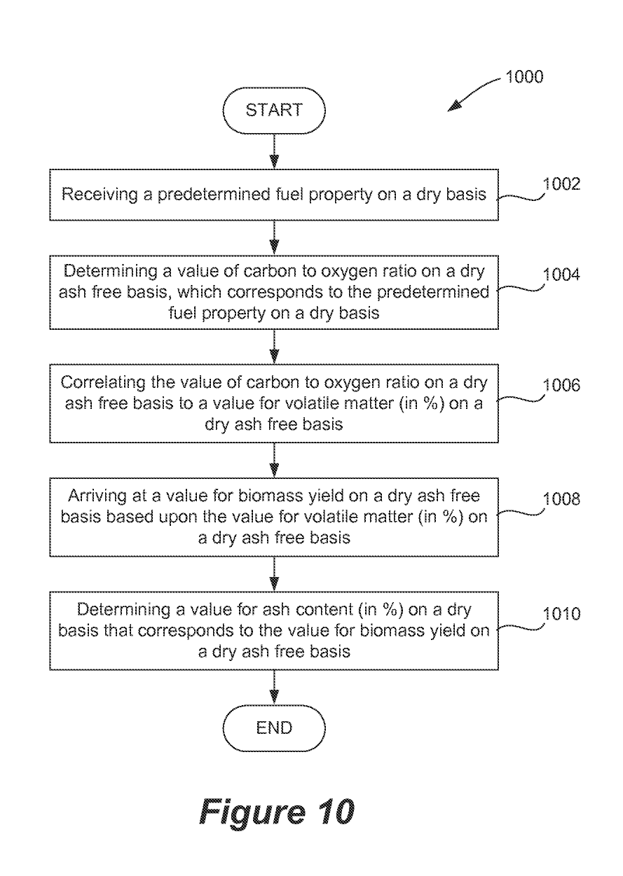

Correlations presented in Equations 7-12 of the present invention allow for determination of the ash content in the fuel based on one fuel property (e.g., HHV), which is typically provided on a dry basis by a Fuel Customer 106 of FIG. 1. To this end. FIG. 10 shows a flowchart for a process 1000 to determine a value for ash content on a dry basis based on a specified fuel property, such as HHV_{dry}.

A step 1002 includes receiving a predetermined fuel property on a dry basis. By way of example, a specific value for HHV_{dry} is received from a fuel customer. In other words, a fuel customer may place a request for purchasing a fuel having a particular value of HHV_{dry}.

Next, a step 1004 includes determining a value of C/O. Continuing with the above example of a request for a specified value of HHV_{dry}, Equation 9 is used to determine a corresponding value of C/O.

Then a step 1006 involves correlating a value of C/O to a value for VM_{DAF}. According to this step, a value for VM_{DAF} may be determined from a value of C/O using Equation 10.

A step 1008 includes arriving at a value for (M/M₀)_{DAF} based upon a value of VM_{DAF} obtained from step 1006. In this step, (M/M₀)_{DAF} may be determined from the value of VM_{DAF} using Equation 11.

A step 1010 includes determining a value for ash content on a dry basis (A_{dry}) that corresponds to the value for (M/M₀)_{DAF} from step 1008. By way of example, a value for A_{dry} is determined from a value of (M/M₀)_{DAF} using Equation 12.

The present invention recognizes that after A_{dry} is determined (i.e., ash content of the fuel is known), then bridge equations (i.e. Equations 13-19 presented below) may be used to convert fuel properties from the DAF regime back to the dry regime. Equations 13-19 are thought of as “bridge equations” because, as explained below, they serve as a bridge between the dry regime and the DAF regime, and vice versa. As mentioned above, fuel specifications are provided in and transactions for purchase of fuel are carried out in the dry basis regime, where various fuel properties simply do not correlate. According to the present invention, fuel properties enjoy strong correlations in the DAF regime. As a result, the bridge equations allow conversion of a specified fuel property, typically desired by a Fuel Customer 106 of FIG. 1, from a dry regime to a DAF regime, where fuel properties enjoy strong correlations (e.g., Equations 1-12), as advanced by the present invention, to compute at least one other fuel property in the DAF regime. One or more of the bridge equations allows conversion of the at least one other computed fuel property in the DAF regime back to the dry regime.

The bridge equations of the present invention include:

$$\begin{matrix}{HHV}_{dry} = {HHV}_{DAF} \frac{( 100 - {A}_{dry} )}{100} & ( Equation 13 ) \\ {FC}_{dry} = {FC}_{DAF} \frac{( 100 - {A}_{dry} )}{100} & ( Equation 14 ) \\ {VM}_{dry} = {VM}_{DAF} \frac{( 100 - {A}_{dry} )}{100} & ( Equation 15 ) \\ {C}_{dry} = {C}_{DAF} \frac{( 100 - {A}_{dry} )}{100} & ( Equation 16 ) \\ {H}_{dry} = {H}_{DAF} \frac{( 100 - {A}_{dry} )}{100} & ( Equation 17 ) \\ {O}_{dry} = {O}_{DAF} \frac{( 100 - {A}_{dry} )}{100} & ( Equation 18 ) \\ {( \frac{M}{{M}_{o}} )}_{dry} = {( \frac{M}{{M}_{o}} )}_{DAF} * \frac{( 100 - {A}_{0 , dry} )}{( 100 - {A}_{dry} )} & ( Equation 19 )\end{matrix}$$

Equation 13 expresses a relationship that allows computing HHV_{dry} from HHV_{DAF}, and vice versa. Equation 14 is directed to fixed carbon (“FC”) and expresses a relationship that allows computing FC_{dry} from FC_{DAF}, and vice versa. As a side note, immediately after biomass is processed to fuel, typically there are negligible amounts of, or no, moisture left. In the DAF regime, therefore, as a practical matter, the following equation holds true:

VM_{DAF}+FC_{DAF}=100 (Equation 20)

Thus, FC_{DAF} is easily calculated from VM_{DAF}.

According to Equation 15, VM_{dry} may also be calculated from VM_{DAF}, and vice versa. Equations 16-19 similarly provide relationships for carbon, hydrogen, oxygen, and mass yield such that their values in the dry regime can be obtained from their values in the DAF regime, and vice versa.

Although process 1000 is explained using an example in which a fuel customer places a request for a desired value of HHV_{dry}, those skilled in the art will appreciate that at least some of Equations 7-19 may similarly be used to arrive at A_{dry}, if the customer requests fuel having specific values of one or more of other fuel properties (e.g., FC_{dry}, VM_{dry}, C_{dry}, H_{dry}, O_{dry} or (M/Mₒ)_{dry}).

According to certain preferred embodiments of the present invention and with reference to FIG. 1, Fuel Production Management Facility 104 obtains from Biomass-Based Fuel Production Plant 102 a value for an amount of initial ash content of biomass on a dry basis (A_{o,dry}) and serves to guide Biomass-Based Fuel Production Plant 102 to produce biomass-based fuel for sale. In this embodiment. Fuel Production Management Facility 104 receives a request from Fuel Customer 106 regarding a request to purchase fuel having a predetermined value of a fuel property on a dry basis (e.g., FC_{dry}, VM_{dry}, C_{dry}, H_{dry}, O_{dry} or (M/Mₒ)_{dry}). To meet the purchase request, Fuel Production Management Facility 104 may convey to Biomass-Based Fuel Production Plant 102 or, in the alternative, compute for their own benefit one value of another fuel property on a dry basis because such value of another property provides insight into the manner in which the available biomass should be processed to meet the particular needs of Fuel Customer 106. As mentioned above to compute one other value of fuel on a dry basis, ash content of fuel on a dry basis (A_{dry}) is preferably first determined. To this end, Fuel Production Management Facility 104 may compute A_{dry} using the known value of A_{o,dry}, the specified or predetermined value of a fuel property and by solving at least one equation from a first set of equations and at least one equation from a second set of equations. The first set of equations includes Equations 13-19 and the second set of equations includes 4-8 and 11-12.

In accordance with one embodiment, the value of A_{dry} computed according to the present invention is conveyed to Biomass-Based Fuel Production Plant 102 for facilitating processing of biomass or to Fuel Customer 106 for facilitating combustion of fuel. In preferred embodiments of the present invention, the value of A_{dry} is conveyed to Biomass-Based Fuel Production Plant 102 for processing of biomass to produce fuel or to Fuel Customer 106 for combusting the ultimately produced fuel. In those embodiments, where A_{dry} is conveyed for biomass processing, preferably thermo-chemical processing in a torrefaction chamber is carried out. In preferred embodiments of the present invention, GCF 1300 Inert Gas Furnace, which is commercially available from Across International of Berkeley Heights, N.J., is used.

According to other preferred embodiments of the present invention. Fuel Production Management Facility 104 obtains from Biomass-Based Fuel Production Plant 102 a value for an amount of initial ash content of biomass on a dry basis (A_{o/dry}) and serves to guide Biomass-Based Fuel Production Plant 102 to produce biomass-based fuel for sale. In this embodiment, Fuel Production Management Facility 104 receives a request from Fuel Customer 106 regarding a request to purchase fuel having a predetermined or, in the alternative, specified ash content (A_{dry}). To meet the purchase request, Fuel Production Management Facility 104 may convey to Biomass-Based Fuel Production Plant 102, or in the alternative, compute for its own benefit one value of another fuel property on a dry basis because such value of another fuel property provides insight into the manner in which the available biomass may be processed to meet the particular needs of Fuel Customer 106. To this end, Fuel Production Management Facility 104 may compute a value of the other fuel property by solving Equation 7, and by solving at least one equation from a first set of equations and at least one equation from a second set of equations. The first set of equations in this embodiment includes Equations 4-8 and 11-12, and the second set of equations includes Equations 13-19.

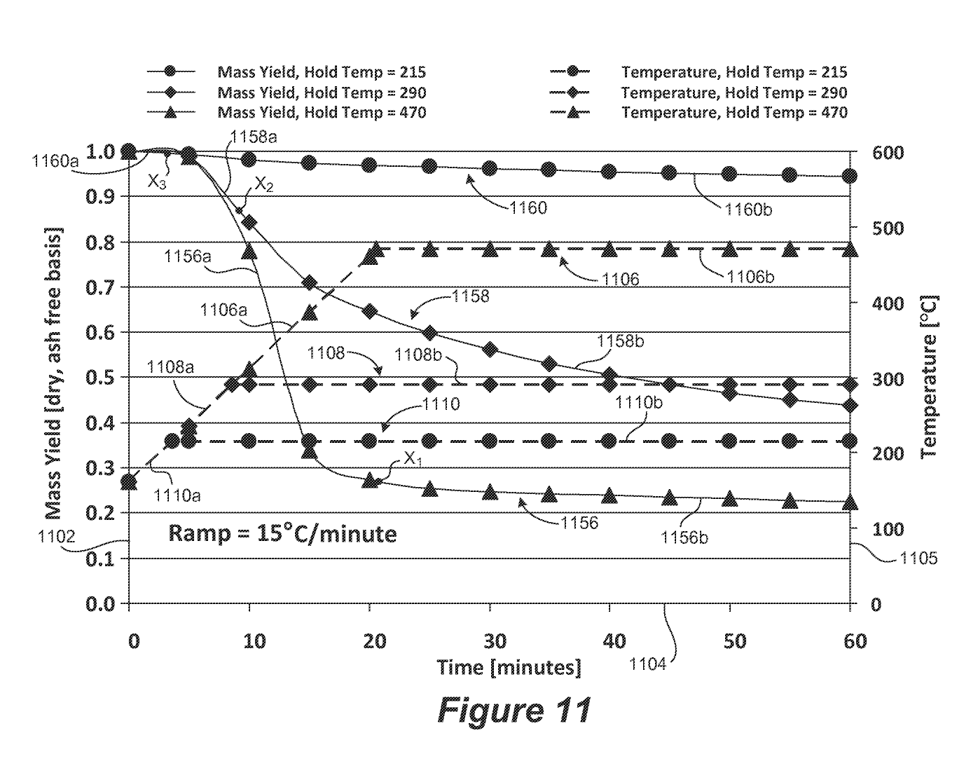

FIG. 11 shows a graph where values for (M/Mₒ)_{DAF} are plotted on a first Y-axis (denoted by 1102) and values for temperature of biomass undergoing processing are plotted on a second Y-axis (denoted by 1105) against values for time of biomass processing that are plotted on an X-axis (denoted by 1104). Units for time of biomass processing are expressed in minutes and for temperature of biomass undergoing processing are expressed in degrees Celsius (° C.). According to the present invention, the graph shown in FIG. 11 is prepared for each type of biomass that is used to produce fuel and prepared for each value of temperature ramp rate. Temperature ramp rate, as that term is used in this specification, refers to the rate of change in temperature of biomass during processing per unit time of biomass processing. FIG. 11 shows hydro-mechanically treated rice straw having an average particle size of 0.12 mm, at a temperature ramp rate of 15° C./minute. The values for mass yield are obtained in the same manner as described with reference to FIG. 4A and values for time and temperature were obtained by conducting torrefaction experiments SII Seiko TG/DTA EXSTAR 6300 instrument, commercially available from Seiko instruments, Inc. of Chiba, Cbiba, Japan.

During biomass processing, as temperature of biomass undergoing processing changes over a period of time, so does a fuel property, e.g., (M/Mₒ)_{DAF}, as shown in FIG. 11. As a result, the change in temperature of the biomass undergoing processing can be thought to have a corresponding relationship to a fuel property. To this end, FIG. 11 shows three temperature plots 1106, 1108 and 1110, which correspond to three fuel property-plots 1156, 1158 and 1160, respectively.

Each temperature plot has two regions, a ramp-rate region and an isothermal region. In the ramp-rate region shown in FIG. 11, the temperature of biomass processing increases at a ramp rate of 15° C./minute. In the isothermal region, the temperature of biomass undergoing processing is held at a constant predetermined temperature, often referred to as the “hold temperature.” For temperature plots 1106, 1108, and 1110, the hold temperatures are 215° C., 290° C., and 470° C., respectively.

Each temperature plot 1106, 1108, and 1110 includes a ramp-rate region 1106a, 1108a and 1110a, respectively, and an isothermal region 1106b, 1108b and 1110b, respectively. In other words, during biomass processing, as shown in FIG. 11, biomass is treated for a first period of time under temperature ramp-rate conditions and for a second period of time under isothermal conditions. Accordingly, a correlation between a fuel property and time is different in the ramp-rate region than in the isothermal region.

Likewise, each fuel property plot 1156, 1158 and 1160 includes a ramp-rate corresponding region 1156a, 1158a and 1160a, respectively, and an isothermal corresponding region 1156b, 1158b and 1160b, respectively. Locations denoted by X₁, X₂ and X₃, on fuel property plots 1156, 1158 and 1160, respectively, show the boundary between the ramp-rate corresponding regions and the isothermal corresponding regions. Thus, regions 1156a, 1158a and 1160a correspond to ramp-rate regions 1106a, 1108a and 1110a, and regions 1156b, 1158b and 1160b correspond to isothermal regions 1106a, 1108a and 1110a, respectively.

To illustrate one advantage of the present invention, each of X₁, X₂, and X₃ shows a value of time on the fuel property plots where a hold temperature is first realized and held through the isothermal region. By way of example, a hold temperature of 470° C. is first realized at location X₁ on fuel property curve 1106, a hold temperature of 290° C. is first realized at location X₂ on fuel property curve 1108, and a hold temperature of 215° C. is first realized at location X₃ on fuel property curve 1110.

The present invention recognizes that in the isothermal region, a fuel property value typically changes in a gradual, tapered fashion. In sharp contrast, for a constant value of a temperature ramp rate, an increase in a value for a hold temperature (which in this case is the same as an increase in the duration of the ramp-rate), results in a drastic biomass weight loss, i.e., proportionately increased conversion of biomass to fuel. By way of example, at any given time during ramp-rate period 1156a, a value for biomass weight loss on plot 1156 (where hold temperature is 490° C.) is greater than a value for biomass weight loss on plot 1158 (where hold temperature is 290° C.), which is in turn greater than a value for biomass weight loss on plot 1160 (where hold temperature is 215° C.). In other words, the longer biomass is treated at a particular ramp rate, a higher amount of biomass is converted to fuel. Although FIG. 11 shows the effect of hold temperatures at a particular ramp rate on biomass weight loss, those skilled in the art will recognize that other fuel properties described herein will drastically change in a similar manner.

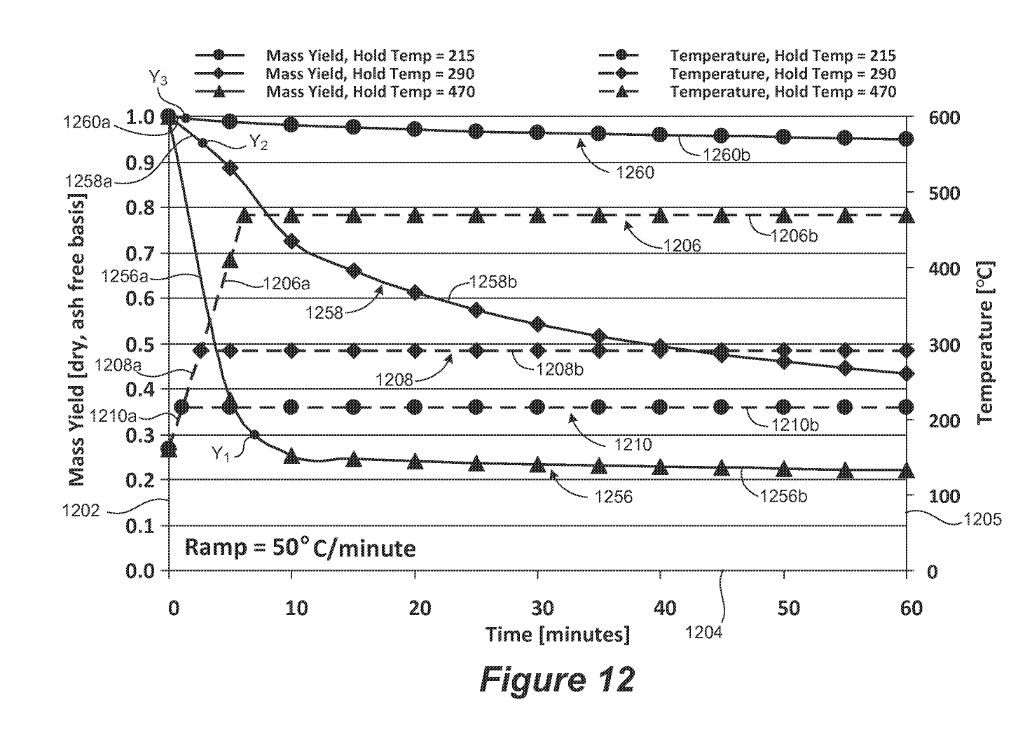

FIG. 12 shows various plots at a temperature ramp rate of 50° C./minute (as opposed to 15° C./minute shown in FIG. 11). Features 1202, 1204, 1205, 1206, 1206a, 1206b, 1208, 1208a, 1208b, 1210, 1210a, 1210b, 1256, 1256a, 1256b, 1258, 1258a, 1258b, 1260, 1260a, 1260b, Y₁, Y₂, and Y₃ shown in FIG. 12 are similar to their counterparts shown in FIG. 11. Furthermore, the correlations in FIGS. 11 and 12 are developed for the same type of biomass.

A comparison of FIGS. 11 and 12 shows that a higher biomass weight loss (i.e., a higher conversion of biomass to fuel) is realized for higher values of temperature ramp rates. At a ramp rate of 15° C./minute (shown in FIG. 11), a biomass weight loss of about 73% is realized after processing the biomass for about 20 minutes. Comparatively, at a ramp rate of 50° C./minute (shown in FIG. 12), about the same amount of biomass weight loss is realized after processing the biomass for about 7 or 8 minutes. Thus, the present invention establishes that when the same type of biomass is used, a much higher throughput for fuel production is realized at higher ramp rates during the ramp-rate period.

In a preferred embodiment of the present invention, the correlations set forth in FIG. 11 are used to obtain a process parameter in the ramp rate region. The present invention recognizes that during a process of torrefaction, knowledge of process parameters such as temperature of ramp rate, time of biomass processing, and temperature of biomass undergoing processing are useful for converting biomass into fuel. By way of example, if one process parameter and one fuel property are known for a given type of biomass, the correlations set forth in the ramp-rate region of FIG. 11 are used to determine the remaining process parameters. It is noteworthy that in the ramp-rate region, the process parameters, i.e., temperature of ramp rate, time of biomass processing, and temperature of biomass, satisfy the following expression:

T=T_{c}+(rt)/60 (Equation 21)

wherein T represents a value of temperature of biomass, Tₒ represents a value of initial temperature of biomass before processing, r represents a value of temperature ramp rate of biomass during processing, and t represents an amount of time of processing biomass.

Knowledge of one such process parameter allows calculation of the remaining process parameters and, thereby facilitates conversion of biomass into fuel. If a fuel customer, e.g. Fuel Customer 106 of FIG. 1, provides a desired value for a fuel property on a dry basis, then bridge equations, i.e., equations 13-19, are used to convert those values to a DAF basis so that it is ultimately used in conjunction with correlations of FIG. 11 to calculate process parameters, as mentioned above.

In preferred embodiments of the present invention, the correlations shown in FIG. 11 or 12 are used to calculate a fuel property when certain process parameters are known in the ramp-rate region. By way of example, for a given type of biomass in the ramp-rate region, if a value for temperature ramp rate of biomass undergoing processing and a value for time of biomass processing or temperature of biomass are known, then a value for a fuel property on a DAF basis is calculated. Furthermore, a value of another fuel property on a DAF basis may be calculated from the above fuel property on a DAF basis by using a value for A_{o,dry}, obtained as mentioned above, and relevant one(s) of Equations 4-8 and 12. The calculated value of another fuel property on a DAF basis may be converted to a value on a dry basis using bridge equations, i.e., equations 13-19.

Typically, knowledge of two fuel properties is important during conversion of biomass to fuel. By way of example, a fuel customer, e.g. Fuel Customer 106, commonly specifies an amount of fuel required (which correlates to (M/Mₒ)_{dry}) and HHV_{dry} when purchasing fuel. In this instance, the above-described techniques ensure that proper settings of process parameters (e.g., at Biomass-Based Fuel Production Plant 102 of FIG. 1) are implemented to obtain a fuel of desired properties.

In a preferred embodiment of the present invention, the correlations set forth in FIG. 11 or 12 are used to arrive at parameters required for processing in the isothermal region. The present invention recognizes that during a process of torrefaction, knowledge of values for at least two process parameters and one fuel property (typically provided by a fuel customer) for a given type of biomass, allows for calculation of the remaining process parameter

In other preferred embodiments of the present invention, the correlations shown in FIG. 11 or 12 are used to calculate a fuel property when the process parameters are known in the isothermal region. As explained above in connection with the ramp-rate region, other fuel properties, either on a DAF basis or on a dry basis, may also be determined to satisfy a fuel customer's demands.

This description of the disclosed aspects of the present invention is provided to enable any person skilled in the art to make or use the present invention. Various modifications to these aspects will be readily apparent to those skilled in the art, and the generic principles defined herein may be applied to other aspects without departing from the spirit or scope of the invention. Moreover, having thus described the invention, it should be apparent that numerous structural modifications and adaptations may be resorted to without departing from the scope and fair meaning of various embodiments of the instant invention as set forth hereinabove and as described herein below by the claims.

What is claimed is:

1. A method of producing a fuel from biomass, said method comprising:
obtaining an information and one process parameter for a type of biomass, said information defining a relationship among time of processing said biomass, temperature of said biomass during processing and a property of said fuel, and values of said time of processing said biomass and values of said temperature of said biomass during processing correlate according to a value of temperature ramp rate of said biomass during processing, and said process parameter includes at least one member selected from a group consisting of said time of processing of said biomass, said temperature of said biomass during processing, and said temperature ramp rate of said biomass during processing;
accessing a value for said property of said fuel on a dry, ash-free basis, wherein said property of said fuel includes one member selected from a group consisting of higher heating value, mass yield, volatile matter, fixed carbon, amount of carbon, amount of oxygen and amount of hydrogen;
determining a value of another process parameter for said biomass type using said property of said fuel on said dry, ash-free basis and said one process parameter; and
processing, using said value of another process parameter for said type of biomass, of said biomass to produce said fuel.

2. The method of claim 1, further comprising obtaining value of an initial temperature of said biomass before processing of said biomass, and a relationship among amount of said time of processing of said biomass, value of said temperature of said biomass during processing, value of said temperature ramp rate of said biomass during processing and said value of said initial temperature of said biomass is expressed according to the following equation:
T=Tₒ+(rt)/60
wherein said T represents said value of said temperature of said biomass, Tₒ represents said value of said initial temperature of said biomass before processing of said biomass, r represents value of said temperature ramp rate of said biomass during processing, and t represents said amount of said time of processing of said biomass.

3. The method of claim 1, wherein said property of said fuel on a dry, ash-free basis includes mass yield of said fuel on said dry, ash-free basis.

4. The method of claim 1, wherein said obtaining said value for said property of said fuel on said dry, ash-free basis includes:
receiving a predetermined value of said property of said fuel on a dry basis; and
converting said predetermined value of said property of said fuel from said dry basis to said dry, ash-free basis.

5. The method of claim 4, wherein said converting said predetermined value of said property of said fuel from said dry basis to said dry, ash-free basis includes:
obtaining a value for an amount of initial ash of said biomass on said dry basis;
accessing a predetermined value of said property of said fuel on said dry basis;
using a microprocessor for computing a value of said property of said fuel on said dry, ash-free basis from said predetermined value of said property of said fuel on said dry basis by using said value of said amount of initial ash of said biomass on said dry basis and by solving a yield equation, solving at least one equation selected from a group consisting of a first set of equations and solving at least one equation selected from a group consisting of a second set of equations, wherein said yield equation is:
$${A}_{dry} = \frac{100}{{( M / {M}_{0} )}_{DAF} \frac{( 100 - {A}_{0 , dry} )}{{A}_{0 , dry}} + 1} ,$$
and said second set of equations includes:
$${HHV}_{DAF} = [ - \frac{α}{( C / O )} * ln ( β ( C / O ) - γ ) + δ ] , \\ {C}_{DAF} = μ + \frac{v}{{( M / {M}_{0} )}_{DAF}} , \\ {H}_{DAF} = ξ - \frac{o}{{( M / {M}_{0} )}_{DAF}} , \\ {O}_{DAF} = π - \frac{ρ}{{( M / {M}_{0} )}_{DAF}} , \\ {VM}_{DAF} = κ - \frac{λ}{{( M / {M}_{0} )}_{DAF}} , and$$
$${FC}_{DAF} = 100 - {VM}_{DAF} ;$$
and said first set of equations includes:
$$\begin{matrix}{HHV}_{dry} = {HHV}_{DAF} \frac{( 100 - {A}_{dry} )}{100} , \\ {FC}_{dry} = {FC}_{DAF} \frac{( 100 - {A}_{dry} )}{100} , \\ {VM}_{dry} = {VM}_{DAF} \frac{( 100 - {A}_{dry} )}{100} , \\ {C}_{dry} = {C}_{DAF} \frac{( 100 - {A}_{dry} )}{100} , \\ {H}_{dry} = {H}_{DAF} \frac{( 100 - {A}_{dry} )}{100} , \\ {O}_{dry} = {O}_{DAF} \frac{( 100 - {A}_{dry} )}{100} , and \\ {( \frac{M}{{M}_{0}} )}_{dry} = {( \frac{M}{{M}_{0}} )}_{DAF} * \frac{( 100 - {A}_{0 , dry} )}{( 100 - {A}_{dry} )} ;\end{matrix}$$
wherein said A_{o,dry} represents said value of said amount of initial ash content of said biomass on a dry basis,
said A_{dry} represents said value of said amount of ash content of said fuel on said dry basis,
said HHV_{dry} represents a value of higher heating value of said fuel on said dry basis
said HHV_{DAF} represents a value of higher heating value of said fuel on said dry, ash-free basis,
said (M/M₀)_{DAF} represents a value of yield of said fuel on said dry, ash-free basis, and
said M represents mass of said fuel,
said M₀ represents mass of said biomass,
said C_{dry} represents an amount of carbon in said fuel on said dry basis,
said C_{DAF} represents an amount of carbon in said fuel on said dry, ash-tree basis,
said O_{dry} represents an amount of oxygen in said fuel on said dry basis,
said O_{DAF} represents an amount of oxygen in said fuel on said dry, ash-free basis,
said (M/M₀)_{dry} represents a value of yield of said fuel on said dry basis, and
wherein said α has a value that is between about 200 and about 300,
said β has a value that is between about 1×10⁷ and about 1×10⁸,
said γ has a value that is between about 1×10⁷ and about 1×10⁸,
said δ has a value that is between about 7000 and about 9000,
said ο has a value that is between about 20 and about 50,
said π has a value that is between about 5 and about 25,
said ν has a value that is between about 8 and about 25,
said ρ has a value that is between about 2 and about 12,
said κ has a value that is between about 80 and about 120,
said ξ has a value that is between about 2 and about 12
said μ has a value that is between about 20 and about 50, and
said λ has a value that is between about 10 and about 35; and
wherein said desired value of said property of said fuel includes at least one member selected from a group consisting of said value of higher heating value on said dry basis, said value of fixed carbon on said dry basis, said value of yield on said dry basis, said value of volatile matter on said dry basis, said amount of carbon on said dry basis, said amount of oxygen on said dry basis and said amount of hydrogen on said dry basis.

6. The method of claim 5, wherein said amount of carbon and said amount of oxygen in said fuel has units of percent, by weight, on a dry, ash-free basis.

7. The method of claim 1, wherein said accessing is carried out using a computer interface.

8. The method of claim 1, wherein said obtaining includes obtaining said value for said amount of initial ash using at least one means selected from a group consisting of a muffle furnace, a high temperature oven, a solid fuel burner, a thermo-gravimetric analyzer, an infrared spectrometer, a near infrared spectrometer, a gamma ray absorber, X-ray fluorescence spectrometer and a microwave absorber.

9. The method of claim 1, further comprising processing of biomass using at least one member selected from a group consisting of a torrefaction chamber, an inert muffle furnace, an inert gas-purged oven, an inert gas-purged kiln, a covered inert chamber, or a covered earthen pit.

10. The method of claim 1, further comprising thermo-chemically processing said biomass to produce said fuel.

11. The method of claim 1, wherein said volatile matter has units of percent, by weight, and said M and said M₀ have units of mass.

12. A method of producing a fuel from biomass, comprising:
obtaining values of a temperature ramp rate of said biomass during processing and values of one process parameter selected from a group consisting of a time of processing of said biomass and a temperature of said biomass during processing;
obtaining an information for a type of said biomass, said information defining a relationship among said time of processing said biomass, said temperature of said biomass during processing and a property of said fuel, and said values of said time of processing said biomass and said values of said temperature of said biomass during processing correlate according to said value of temperature ramp rate of said biomass during processing;
determining a value of said property of said fuel on a dry, ash-free basis, for said biomass type using said values of said temperature ramp rate of said biomass during processing and said value of said one process parameter, and wherein said property of said fuel includes one member selected from a group consisting of higher heating value, mass yield, volatile matter, fixed carbon, amount of carbon, amount of oxygen and amount of hydrogen; and
processing said biomass using said value of said property of said fuel on a dry, ash-free basis, to produce said fuel.

13. The method of claim 12, wherein said obtaining said information for said type of said biomass includes performing one step selected from a group consisting of conducting thermogravimetric experiments, conducting an elemental content analysis, thermochemical experiments, and using at least one member selected from a group consisting of a carbon-hydrogen-nitrogen-sulfur analyzer, a carbon-hydrogen-nitrogen-oxygen analyzer, a gaseous mass analyzer, a mass spectrometer, an infrared spectrometer, a thermal conductivity cell, a muffle furnace, an inert muffle furnace, a high temperature oven, a solid fuel burner, a thermo-gravimetric analyzer, an infrared spectrometer, a near infrared spectrometer, an x-ray fluorescence spectrometer, a gamma ray absorber, a microwave absorber, a bomb calorimeter, a differential thermal analyzer, and a differential scanning calorimeter.

14. The method of claim 12, further comprising determining a value of another property of said fuel and said determining includes:
obtaining a value for an amount of initial ash of said biomass on a dry basis,
using a microprocessor for computing said value of said another property of said fuel on a dry, ash-free basis from said value of said amount of initial ash of said biomass on said dry basis and said value of said property of said fuel on a dry, ash-free basis, by solving a yield equation, and solving at least one equation selected from a group consisting of a first set of equations, wherein said yield equation includes:
$${A}_{dry} = \frac{100}{{( M / {M}_{0} )}_{DAF} \frac{( 100 - {A}_{0 , dry} )}{{A}_{0 , dry}} + 1} ,$$
and said first set of equations includes:
$${HHV}_{DAF} = [ - \frac{α}{( C / O )} * ln ( β ( C / O ) - γ ) + δ ] , \\ {C}_{DAF} = μ + \frac{v}{{( M / {M}_{0} )}_{DAF}} , \\ {H}_{DAF} = ξ - \frac{o}{{( M / {M}_{0} )}_{DAF}} , \\ {O}_{DAF} = π - \frac{ρ}{{( M / {M}_{0} )}_{DAF}} , and$$
$${VM}_{DAF} = κ - \frac{λ}{{( M / {M}_{0} )}_{DAF}} ;$$
wherein said A_{o,dry} represents said value of said amount of initial ash content of said biomass on a dry basis,
said A_{dry} represents said value of said amount of ash content of said fuel on said dry-basis,
said HHV_{DAF} represents a value of higher heating value of said fuel on a dry, ash-free basis,
said (M/Mₒ)_{DAF} represents a value of yield of said fuel on said dry, ash-free basis, and
said M represents mass of said fuel,
said M₀ represents mass of said biomass,
said C_{DAF} represents an amount of carbon in said fuel on said dry, ash-free basis,
said O_{dry} represents an amount of oxygen in said fuel on said dry basis,
said O_{DAF} represents an amount of oxygen in said fuel on said dry, ash-free basis,
wherein said α has a value that is between about 200 and about 300,
said β has a value that is between about 1×10⁷ and about 1×10⁸,
said γ has a value that is between about 1×10⁷ and about 1×10⁸,
said δ has a value that is between about 7000 and about 9000,
said ο has a value that is between about 20 and about 50,
said π has a value that is between about 5 and about 2.5,
said ν has a value that is between about 8 and about 25,
said ρ has a value that is between about 2 and about 12,
said κ has a value that is between about 80 and about 120,
said ξ has a value that is between about 2 and about 12
said λ has a value that is between about 10 and about 35, and
said μ has a value that is between about 20 and about 50.

15. The method of claim 14, further comprising converting said value of said another property of said fuel from dry, ash-free basis to said dry basis by solving at least one equation selected from a group consisting of:
$$\begin{matrix}{HHV}_{dry} = {HHV}_{DAF} \frac{( 100 - {A}_{dry} )}{100} , \\ {FC}_{dry} = {FC}_{DAF} \frac{( 100 - {A}_{dry} )}{100} , \\ {VM}_{dry} = {VM}_{DAF} \frac{( 100 - {A}_{dry} )}{100} , \\ {C}_{dry} = {C}_{DAF} \frac{( 100 - {A}_{dry} )}{100} , \\ {H}_{dry} = {H}_{DAF} \frac{( 100 - {A}_{dry} )}{100} , \\ {O}_{dry} = {O}_{DAF} \frac{( 100 - {A}_{dry} )}{100} , and \\ {( \frac{M}{{M}_{0}} )}_{dry} = {( \frac{M}{{M}_{0}} )}_{DAF} * \frac{( 100 - {A}_{0 , dry} )}{( 100 - {A}_{dry} )} ;\end{matrix}$$
wherein said HHV_{dry} represents a value of higher heating value of said fuel on said dry basis,
said C_{dry} represents an amount of carbon in said fuel on said dry basis,
said O_{dry} represents an amount of oxygen in said fuel on said dry basis,
said H_{dry} represents an amount of hydrogen in said fuel on said dry basis,
said FC_{dry} represents an amount of fixed carbon in said fuel on said dry basis,
said VM_{dry} represents an amount of volatile matter in said fuel on said dry basis, and
said (M/M₀)_{dry} represents a value of yield of said fuel on said dry basis.

16. A process of producing a fuel from biomass, comprising:
obtaining information and two process parameters for a type of biomass, said information defining a relationship between a property of said fuel on a dry, ash-free basis, and time of processing of said biomass, when said biomass is held at a constant temperature after being heated to said constant temperature based on a value of a temperature ramp rate, and a correlation between said property of said fuel and said time of processing of said biomass at said constant temperature of said biomass depends upon a value of said constant temperature and a temperature ramp rate of said biomass, and said process parameter includes said time of processing of said biomass, said constant temperature, and said temperature ramp rate of said biomass;
accessing a value for a property of said fuel on said dry, ash-free basis, wherein said property of said fuel includes one member selected from a group consisting of higher heating value, mass yield, volatile matter, fixed carbon, amount of carbon, amount of oxygen and amount of hydrogen;
determining another process parameter using said property of said fuel on said dry, ash-free basis and said process parameter; and
facilitating combustion of fuel or processing of biomass using said another process parameter.

17. The method of claim 16, wherein said property of said fuel on a dry, ash-free basis includes mass yield of said fuel on said dry, ash-free basis.

18. The method of claim 1, wherein said obtaining said value for said property of said fuel on said dry, ash free-basis includes:
receiving a predetermined value of said property of said fuel on a dry basis; and
converting said predetermined value of said property of said fuel from said dry basis to said dry, ash free-basis.

19. The method of claim 18, wherein said converting said predetermined value of said property of said fuel from said dry basis to said dry, ash-free basis includes:
obtaining a value for an amount of initial ash of said biomass on said dry basis;
accessing a predetermined value of said property of said fuel on said dry basis;
using a microprocessor for computing a value of said property of said fuel on said dry, ash-free basis from said predetermined value of said property of said fuel on said dry basis by using said value of said amount of initial ash of said biomass on said dry basis and by solving a yield equation, solving at least one equation selected from a group consisting of a first set of equations and at least one equation selected from a group consisting of a second set of equations, wherein said yield equation includes:
$${A}_{dry} = \frac{100}{{( M / {M}_{0} )}_{DAF} \frac{( 100 - {A}_{0 , dry} )}{{A}_{0 , dry}} + 1} ,$$
and said second set of equations includes:
$${HHV}_{DAF} = [ - \frac{α}{( C / O )} * ln ( β ( C / O ) - γ ) + δ ] , \\ {C}_{DAF} = μ + \frac{v}{{( M / {M}_{0} )}_{DAF}} , \\ {H}_{DAF} = ξ - \frac{o}{{( M / {M}_{0} )}_{DAF}} , \\ {O}_{DAF} = π - \frac{ρ}{{( M / {M}_{0} )}_{DAF}} , \\ {VM}_{DAF} = κ - \frac{λ}{{( M / {M}_{0} )}_{DAF}} , and$$
$${FC}_{DAF} = 100 - {VM}_{DAF} ;$$
and said first set of equations includes:
$$\begin{matrix}{HHV}_{dry} = {HHV}_{DAF} \frac{( 100 - {A}_{dry} )}{100} , \\ {FC}_{dry} = {FC}_{DAF} \frac{( 100 - {A}_{dry} )}{100} , \\ {VM}_{dry} = {VM}_{DAF} \frac{( 100 - {A}_{dry} )}{100} , \\ {C}_{dry} = {C}_{DAF} \frac{( 100 - {A}_{dry} )}{100} , \\ {H}_{dry} = {H}_{DAF} \frac{( 100 - {A}_{dry} )}{100} , \\ {O}_{dry} = {O}_{DAF} \frac{( 100 - {A}_{dry} )}{100} , and \\ {( \frac{M}{{M}_{0}} )}_{dry} = {( \frac{M}{{M}_{0}} )}_{DAF} * \frac{( 100 - {A}_{0 , dry} )}{( 100 - {A}_{dry} )} ;\end{matrix}$$
wherein said A_{o,dry} represents said value of said amount of initial ash content of said biomass on a dry basis,
said A_{dry} represents said value of said amount of ash content of said fuel on said dry basis,
said HHV_{dry} represents a value of higher heating value of said fuel on a dry basis
said HHV_{DAF} represents a value of higher heating value of said fuel on a dry, ash-free basis,
said (M/M₀)_{DAF} represents a value of yield of said fuel on said dry, ash-free basis, and
said M represents mass of said fuel,
said M₀ represents mass of said biomass,
said O_{dry} represents an amount of carbon in said fuel on said dry basis,
said C_{DAF} represents an amount of carbon in said fuel on said dry, ash-free basis,
said O_{dry} represents an amount of oxygen in said fuel on said dry basis,
said O_{DAF} represents an amount of oxygen in said fuel on said dry, ash-free basis,
said (M/M₀)_{dry} represents a value of yield of said fuel on said dry basis, and
wherein said α has a value that is between about 200 and about 300,
said β has a value that is between about 1×10⁷ and about 1×10⁸,
said γ has a value that is between about 1×10⁷ and about 1×10⁸,
said δ has a value that is between about 7000 and about 9000,
said ο has a value that is between about 20 and about 50,
said π has a value that is between about 5 and about 25,
said ν has a value that is between about 8 and about 25,
said ρ has a value that is between about 2 and about 12,
said κ has a value that is between about 80 and about 120,
said ξ has a value that is between about 2 and about 12
said μ has a value that is between about 20 and about 50, and
said λ has a value that is between about 10 and about 35; and
wherein said desired value of said property of said fuel includes at least one member selected from a group consisting of said value of higher heating value on said dry basis, said value of fixed carbon on said dry basis, said value of yield on said dry basis, said value of volatile matter on said dry basis, said amount of carbon on said dry basis, said amount of oxygen on said dry basis and said amount of hydrogen on said dry basis.

20. The method of claim 19, wherein said amount of carbon and said amount of oxygen in said fuel has units of percent, by weight, on a dry, ash-free basis.

21. The method of claim 16, wherein said accessing is carried out using a computer interface.

22. The method of claim 1, wherein said obtaining includes obtaining said value for said amount of initial ash using at least one means selected from a group consisting of a muffle furnace, a high temperature oven, a solid fuel burner, a thermo-gravimetric analyzer, an infrared spectrometer, a near infrared spectrometer, a gamma ray absorber, X-ray fluorescence spectrometer and a microwave absorber.

23. The method of claim 1, further comprising processing of biomass using at least one member selected from a group consisting of a torrefaction chamber, an inert muffle furnace, an inert gas-purged oven, an inert gas-purged kiln, a covered inert chamber, or a covered earthen pit.

24. The method of claim 1, further comprising thermo-chemically processing said biomass to produce said fuel.

25. The method of claim 1, wherein said volatile matter has units of percent, by weight, and said M and said Mₒ have units of mass.

26. A method of producing a fuel from biomass, comprising:
obtaining values of a temperature ramp rate of said biomass during processing, a time of processing of said biomass and a constant temperature of said biomass during processing;
obtaining an information for a type of said biomass, said information defining a relationship between said property of said fuel on a dry, ash-free basis, and time of processing of said biomass, when said biomass is held at said constant temperature after being heated to said constant temperature based on a value of a temperature ramp rate, and a correlation between said property of said fuel and said time of processing of said biomass at said constant temperature of said biomass depends upon said value of said constant temperature and said value of said temperature ramp rate of said biomass;
determining a value of said property of said fuel on a dry, ash-free basis, for said biomass type using said values of said temperature ramp rate of said biomass during processing and said value of said one process parameter, and wherein said property of said fuel includes one member selected from a group consisting of higher heating value, mass yield, volatile matter, fixed carbon, amount of carbon, amount of oxygen and amount of hydrogen; and
processing said biomass using said value of said property of said fuel on a dry, ash-free basis, to produce said fuel.

27. The method of claim 26, wherein said obtaining said information for a type of said biomass includes performing one step selected from a group consisting of conducting thermogravimetric experiments, conducting an elemental content analysis, thermochemical experiments, and using at least one member selected from a group consisting of a carbon-hydrogen-nitrogen-sulfur analyzer, a carbon-hydrogen-nitrogen-oxygen analyzer, a gaseous mass analyzer, a mass spectrometer, an infrared spectrometer, a thermal conductivity cell, a muffle furnace, an inert muffle furnace, a high temperature oven, a solid fuel burner, a thermo-gravimetric analyzer, an infrared spectrometer, a near infrared spectrometer, an x-ray fluorescence spectrometer, a gamma ray absorber, a microwave absorber, a bomb calorimeter, a differential thermal analyzer, and a differential scanning calorimeter.

28. The method of claim 26, further comprising determining a value of another property of said fuel and said determining includes:
obtaining a value for an amount of initial ash of said biomass on a dry basis,
using a microprocessor for computing said value of said another property of said fuel on a dry, ash-free basis from said value of said amount of initial ash of said biomass on said dry basis and said value of said property of said fuel on a dry, ash-free basis, by solving a yield equation, and solving at least one equation selected from a group consisting of a first set of equations, wherein said yield equation includes:
$${A}_{dry} = \frac{100}{{( M / {M}_{0} )}_{DAF} \frac{( 100 - {A}_{0 , dry} )}{{A}_{0 , dry}} + 1} ,$$
and said first set of equations includes:
$${HHV}_{DAF} = [ - \frac{α}{( C / O )} * ln ( β ( C / O ) - γ ) + δ ] , \\ {C}_{DAF} = μ + \frac{v}{{( M / {M}_{0} )}_{DAF}} , \\ {H}_{DAF} = ξ - \frac{o}{{( M / {M}_{0} )}_{DAF}} , \\ {O}_{DAF} = π - \frac{ρ}{{( M / {M}_{0} )}_{DAF}} , \\ {VM}_{DAF} = κ - \frac{λ}{{( M / {M}_{0} )}_{DAF}} , and$$
$${FC}_{DAF} = 100 - {VM}_{DAF} ;$$
wherein said A_{o,dry} represents said value of said amount of initial ash content of said biomass on a dry basis,
said A_{dry} represents said value of said amount of ash content of said fuel on said dry basis,
said HHV_{DAF} represents a value of higher heating value of said fuel on a dry, ash-free basis,
said (M/M₀)_{DAF} represents a value of yield of said fuel on said dry, ash-free basis, and
said M represents mass of said fuel,
said M₀ represents mass of said biomass,
said C_{DAF} represents an amount of carbon in said fuel on said dry, ash-free basis,
said O_{dry} represents an amount of oxygen in said fuel on said dry basis,
said O_{DAF} represents an amount of oxygen in said fuel on said dry, ash-free basis,
wherein said α has a value that is between about 200 and about 300,
said β has a value that is between about 1×10⁷ and about 1×10⁸,
said γ has a value that is between about 1×10⁷ and about 1×10⁸,
said δ has a value that is between about 7000 and about 9000,
said ο has a value that is between about 20 and about 50,
said π has a value that is between about 5 and about 25,
said ν has a value that is between about 8 and about 25,
said ρ has a value that is between about 2 and about 12,
said κ has a value that is between about 80 and about 120,
said ξ has a value that is between about 2 and about 12
said λ has a value that is between about 10 and about 35, and
said μ has a value that is between about 20 and about 50.

29. The method of claim 28, further comprising converting said value of said another property of said fuel from dry, ash-free basis to said dry basis by solving at least one equation selected from a group consisting of:
$$\begin{matrix}{HHV}_{dry} = {HHV}_{DAF} \frac{( 100 - {A}_{dry} )}{100} , \\ {FC}_{dry} = {FC}_{DAF} \frac{( 100 - {A}_{dry} )}{100} , \\ {VM}_{dry} = {VM}_{DAF} \frac{( 100 - {A}_{dry} )}{100} , \\ {C}_{dry} = {C}_{DAF} \frac{( 100 - {A}_{dry} )}{100} , \\ {H}_{dry} = {H}_{DAF} \frac{( 100 - {A}_{dry} )}{100} , \\ {O}_{dry} = {O}_{DAF} \frac{( 100 - {A}_{dry} )}{100} , and \\ {( \frac{M}{{M}_{0}} )}_{dry} = {( \frac{M}{{M}_{0}} )}_{DAF} * \frac{( 100 - {A}_{0 , dry} )}{( 100 - {A}_{dry} )} ;\end{matrix}$$
wherein said HHV_{dry} represents a value of higher heating value of said fuel on said dry basis,
said C_{dry} represents an amount of carbon in said fuel on said dry basis,
said O_{dry} represents an amount of oxygen in said fuel on said dry basis,
said H_{dry} represents an amount of hydrogen in said fuel on said dry basis,
said FC_{dry} represents an amount of fixed carbon in said fuel on said dry basis,
said VM_{dry} represents an amount of volatile matter in said fuel on said dry basis, and
said (M/M₀)_{dry} represents a value of yield of said fuel on said dry basis.

30. A system for producing a fuel from biomass, said system comprising:
means for obtaining an information and one process parameter for a type of biomass, said information defining a relationship among time of processing said biomass, temperature of said biomass during processing and a property of said fuel, and values of said time of processing said biomass and values of said temperature of said biomass during processing correlate according to a value of temperature ramp rate of said biomass during processing, and said process parameter includes at least one member selected from a group consisting of said time of processing of said biomass, said temperature of said biomass during processing, and said temperature ramp rate of said biomass during processing;
means for accessing a value for said property of said fuel on a dry, ash-free basis, wherein said property of said fuel includes one member selected from a group consisting of higher heating value, mass yield, volatile matter, fixed carbon, amount of carbon, amount of oxygen and amount of hydrogen;
means for determining a value of another process parameter for said biomass type using said property of said fuel on said dry, ash-free basis and said one process parameter; and
means for processing, using said value of another process parameter for said biomass type, of said biomass to produce said fuel.

31. A system for producing a fuel from biomass, said system comprising:
means for obtaining values of a temperature ramp rate of said biomass during processing and values of one process parameter selected from a group consisting of a time of processing of said biomass and a temperature of said biomass during processing;
means for obtaining an information for a type of said biomass, said information defining a relationship among said time of processing said biomass, said temperature of said biomass during processing and a property of said fuel, and said values of said time of processing said biomass and said values of said temperature of said biomass during processing correlate according to said value of temperature ramp rate of said biomass during processing;
means for determining a value of said property of said fuel on a dry, ash-free basis, for said biomass type using said values of said temperature ramp rate of said biomass during processing and said value of said one process parameter, and wherein said property of said fuel includes one member selected from a group consisting of higher heating value, mass yield, volatile matter, fixed carbon, amount of carbon, amount of oxygen and amount of hydrogen; and
means for processing said biomass using said value of said property of said fuel on a dry, ash-free basis, to produce said fuel.

32. A system for producing a fuel from biomass, said system comprising:
means for obtaining information and two process parameters for a type of biomass, said information defining a relationship between a property of said fuel on a dry, ash-free basis, and time of processing of said biomass, when said biomass is held at a constant temperature after being heated to said constant temperature based on a value of a temperature ramp rate, and a correlation between said property of said fuel and said time of processing of said biomass at said constant temperature of said biomass depends upon a value of said constant temperature and a temperature ramp rate of said biomass, and said process parameter includes said time of processing of said biomass, said constant temperature, and said temperature ramp rate of said biomass;
means for accessing a value for a property of said fuel on said dry, ash-free basis, wherein said property of said fuel includes one member selected from a group consisting of higher heating value, mass yield, volatile matter, fixed carbon, amount of carbon, amount of oxygen and amount of hydrogen;
means for determining another process parameter using said property of said fuel on said dry, ash-free basis and said process parameter; and
means for facilitating combustion of fuel or processing of biomass using said another process parameter.

33. A system for producing a fuel from biomass, said system comprising:
means for obtaining values of a temperature ramp rate of said biomass during processing, a time of processing of said biomass and a constant temperature of said biomass during processing;
means for obtaining an information for a type of said biomass, said information defining a relationship between said property of said fuel on a dry, ash-free basis, and time of processing of said biomass, when said biomass is held at said constant temperature after being heated to said constant temperature based on a value of a temperature ramp rate, and a correlation between said property of said fuel and said time of processing of said biomass at said constant temperature of said biomass depends upon said value of said constant temperature and said value of said temperature ramp rate of said biomass;
means for determining a value of said property of said fuel on a dry, ash-free basis, for said biomass type using said values of said temperature ramp rate of said biomass during processing and said value of said one process parameter, and wherein said property of said fuel includes one member selected from a group consisting of higher heating value, mass yield, volatile matter, fixed carbon, amount of carbon, amount of oxygen and amount of hydrogen; and
means for processing said biomass using said value of said property of said fuel on a dry, ash-free basis, to produce said fuel.
